(19) United States
(12) Patent Application Publication
(10) Pub. No.: US 2026/0238966 A1
(43) Pub. Date: Aug. 13, 2026

(54) DESIGN ON ROUTING MANAGEMENT AND CONFIGURATION FOR AUTONOMOUS UAV

(71) Applicant: QUALCOMM Incorporated, San Diego, CA (US)

(72) Inventors: Mingxi YIN, Beijing (CN); Ruiming ZHENG, Beijing (CN); Kangqi LIU, San Diego, CA (US); Chao WEI, Beijing (CN); Hao XU, Beijing (CN)

(21) Appl. No.: 18/881,251

(22) PCT Filed: Aug. 22, 2022
(86) PCT No.: PCT/CN2022/113820

§ 371 Date: Jan. 3, 2025

(51) Int. Cl. H04W 4/12; H04W 64/00; H04W 76/20; H04W 84/06

(52) U.S. Cl. CPC H04W 4/12; H04W 64/00; H04W 76/20; H04W 84/06

(57) ABSTRACT

The present disclosure provides a managed, regulated use of airspace and flight operations/configurations for UAVs. Route management, operational mode, emergency overrides, and network control of UAV routing and operations are possible within the scope of the present disclosure. An apparatus for wireless communication in accordance with the disclosure may include a memory, and at least one processor coupled to the memory and configured to transmit uncrewed aerial vehicle (UAV) data supporting uplink communication and downlink communication with a network entity, and receive, from the network entity, a message including a UAV driving mode, the UAV driving mode indicating the apparatus to fly on a planned route, the apparatus being a UAV.

### BACKGROUND

### Technical Field

The present disclosure generally relates to communication systems, and more particularly, to a wireless communication system allowing routing management and configuration for autonomous uncrewed aerial vehicles (UAV).

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

For example, some aspects of wireless communication include direct communication between devices, such as device-to-device (D2D), vehicle-to-everything (V2X), and the like. There exists a need for further improvements in such direct communication between devices. Improvements related to direct communication between devices may be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The present disclosure provides a managed, regulated use of airspace and flight operations/configurations for uncrewed aerial vehicles (UAVs). Route management, operational mode, emergency overrides, and network control of UAV routing and operations are possible within the scope of the present disclosure.

In various aspects of the disclosure, a method, a computer-readable medium, and an apparatus are provided. The apparatus may be a user equipment (UE). An apparatus for wireless communication in accordance with an aspect of the present disclosure includes a memory, and at least one processor coupled to the memory and configured to transmit UAV data supporting uplink communication and downlink communication with a network entity, and receive, from the network entity, a message including a UAV driving mode, the UAV driving mode indicating the apparatus to fly on a planned route, the apparatus being a UAV.

A method of wireless communication at a UE in accordance with an aspect of the present disclosure comprises transmitting UAV data supporting uplink communication and downlink communication with a network entity, and receiving, from the network entity, a message including a UAV driving mode, the UAV driving mode indicating the UE to fly on a planned route, the UE being a UAV.

An apparatus for wireless communication in accordance with an aspect of the present disclosure comprises means for transmitting UAV data supporting uplink communication and downlink communication with a network entity, and means for receiving, from the network entity, a message including a UAV driving mode, the UAV driving mode indicating the apparatus to fly on a planned route, the apparatus being a UAV.

A non-transitory computer-readable medium in accordance with an aspect of the present disclosure stores computer executable code, the code when executed by a processor cause the processor to: transmit UAV data supporting uplink communication and downlink communication with a network entity, and receive, from the network entity, a message including a UAV driving mode, the UAV driving mode indicating an apparatus to fly on a planned route, the apparatus being a UAV.

In various aspects of the disclosure, a method, a computer-readable medium, and an apparatus are provided. The apparatus may be a network entity. An apparatus for wireless communication in accordance with an aspect of the present disclosure includes a memory, and at least one processor coupled to the memory and configured to receive UAV data supporting uplink communication and downlink communication with a UE, the UE being a UAV, and transmit a message including a UAV driving mode, the UAV driving mode indicating the UE to fly on a planned route.

A method of wireless communication at a network entity in accordance with an aspect of the present disclosure comprises receiving UAV data supporting uplink communication and downlink communication with a UE, the UE being a UAV; and transmitting a message including a UAV driving mode, the UAV driving mode indicating the UE to fly on a planned route.

An apparatus for wireless communication in accordance with an aspect of the present disclosure comprises means for receiving UAV data supporting uplink communication and downlink communication with a UE, the UE being a UAV and means for transmitting a message including a UAV driving mode, the UAV driving mode indicating the UE to fly on a planned route.

A non-transitory computer-readable medium in accordance with an aspect of the present disclosure stores computer executable code, the code when executed by a processor cause the processor to receive UAV data supporting uplink communication and downlink communication with a UE, the UE being a UAV and transmit a message including a UAV driving mode, the UAV driving mode indicating the UE to fly on a planned route.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a block diagram illustrating an example disaggregated base station architecture in accordance with various aspects of the present disclosure.

FIG. 5 illustrates a flow diagram of network communication in accordance with an aspect of the present disclosure.

FIG. 6 illustrates a flow diagram of network communication in accordance with an aspect of the present disclosure.

FIG. 7 illustrates a flow diagram of network communication in accordance with an aspect of the present disclosure.

FIG. 8A illustrates network route planning in accordance with an aspect of the present disclosure.

FIG. 8B illustrates network route planning in accordance with an aspect of the present disclosure.

FIG. 8C illustrates network route planning in accordance with an aspect of the present disclosure.

FIG. 9 illustrates a flow diagram of network communication in accordance with an aspect of the present disclosure.

FIGS. 10A-10D are flowcharts of a method of wireless communication at a UE in accordance with an aspect of the present disclosure.

FIGS. 11A-11D are flowcharts of a method of wireless communication at a network entity in accordance with an aspect of the present disclosure.

FIG. 12 is a diagram illustrating an example of a hardware implementation for an example apparatus.

FIG. 13 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The present disclosure provides a managed, regulated use of airspace and flight operations/configurations for UAVs. Route management, operational mode, emergency overrides, and network control of UAV routing and operations are possible within the scope of the present disclosure.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

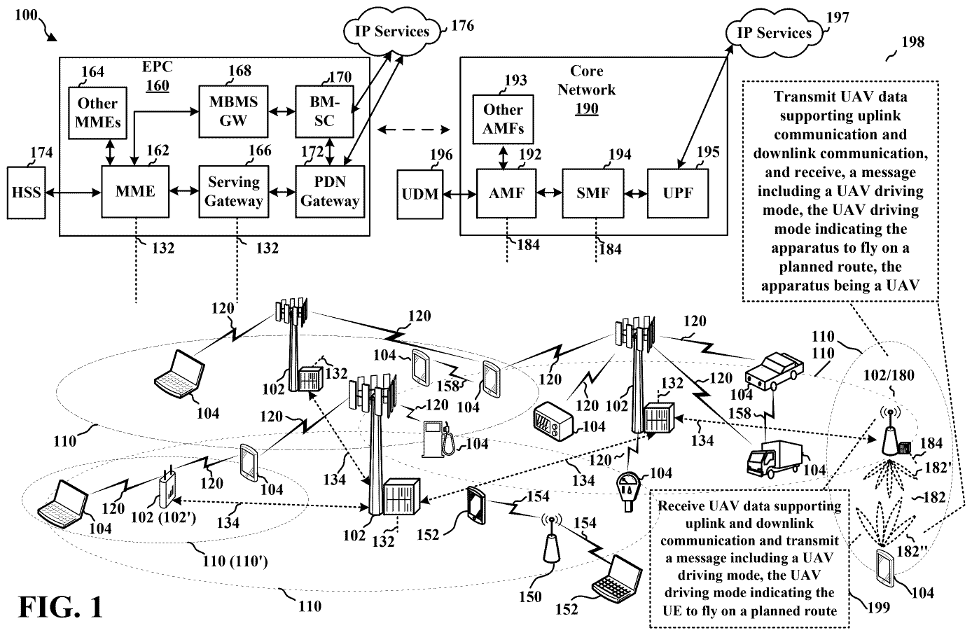

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR 1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

Further, although the present disclosure may focus on UAV communications, the concepts and various aspects described herein may be applicable to other similar areas, such as vehicle-to-everything (V2X) communication, D2D communication, IoT communication, Industrial IoT (IIoT) communication, and/or other standards/protocols for communication in wireless/access networks. Additionally or alternatively, the concepts and various aspects described herein may be of particular applicability to one or more specific areas, such as vehicle-to-pedestrian (V2P) communication, pedestrian-to-vehicle (P2V) communication, vehicle-to-infrastructure (V2I) communication, and/or other frameworks/models for communication in wireless/access networks.

Referring again to FIG. 1, in certain aspects, the UE 104 may be configured to transmit UAV data supporting uplink communication and downlink communication, and receive, a message including a UAV driving mode, the UAV driving mode indicating the apparatus to fly on a planned route, the apparatus being a UAV as shown in UAV component 198.

Referring again to FIG. 1, in certain aspects, the base station 180 may be configured to receive UAV data supporting uplink communication and downlink communication with a UE, the UE being a UAV; and transmit a message including a UAV driving mode, the UAV driving mode indicating the UE to fly on a planned route as shown in base station component 199.

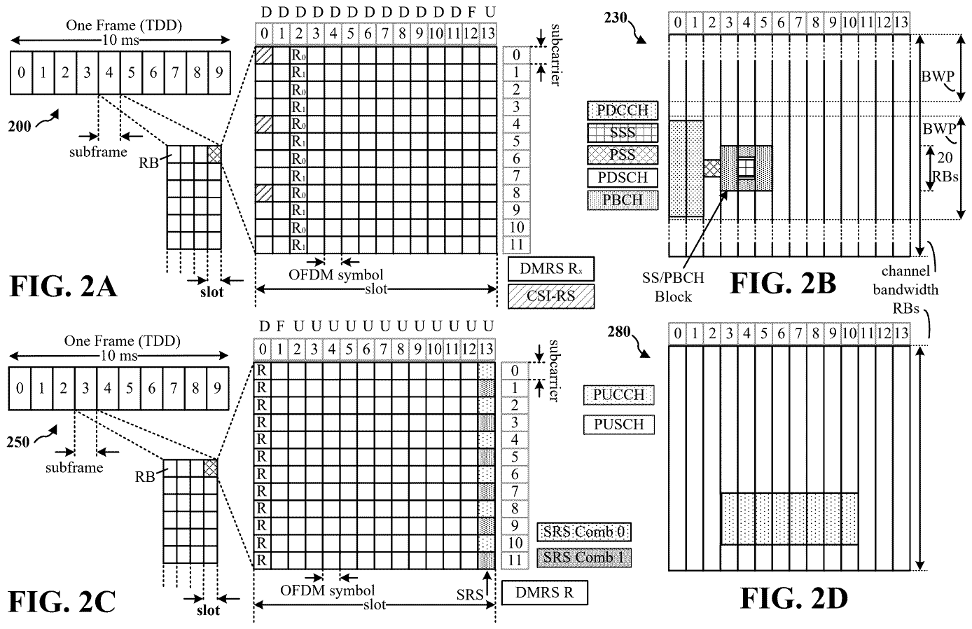

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

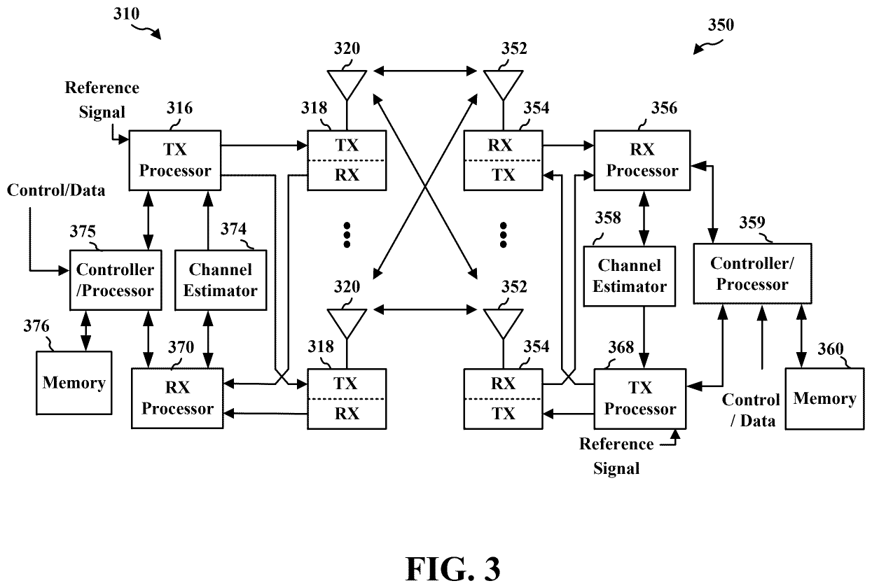

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with UAV component 198 of FIG. 1.

At least one of the TX processor 316, the RX processor 370, and the controller/processor 375 may be configured to perform aspects in connection with 198 of basestation component 199 FIG. 1.

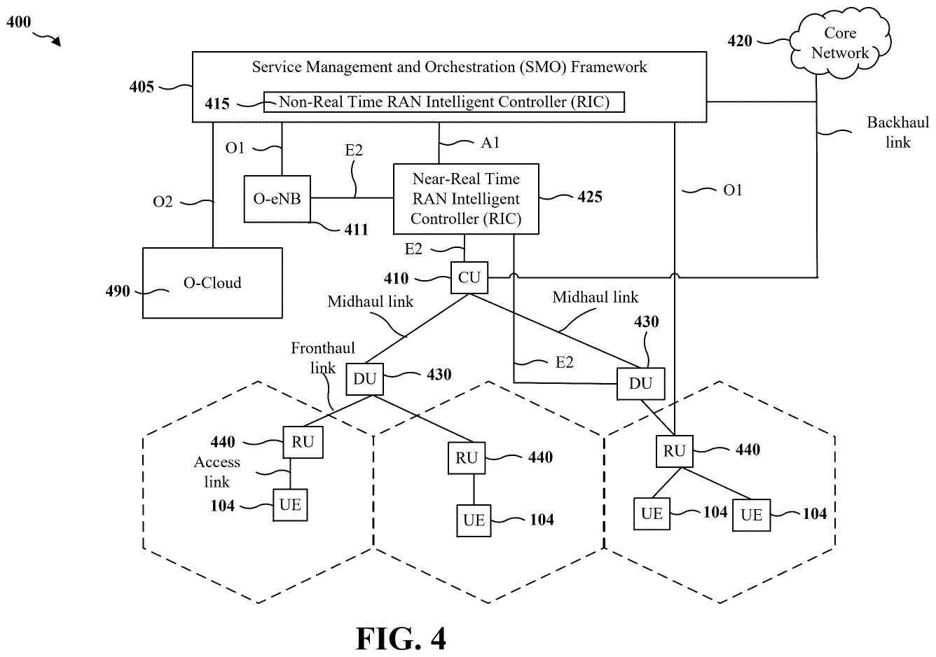

FIG. 4 is a block diagram illustrating an example disaggregated base station 400 architecture. The disaggregated base station 400 architecture may include one or more CUs 410 that can communicate directly with a core network 420 via a backhaul link, or indirectly with the core network 420 through one or more disaggregated base station units (such as a near real-time (RT) RIC 425 via an E2 link, or a non-RT RIC 415 associated with a service management and orchestration (SMO) Framework 405, or both). A CU 410 may communicate with one or more DUs 430 via respective midhaul links, such as an F1 interface. The DUs 430 may communicate with one or more RUs 440 via respective fronthaul links. The RUs 440 may communicate with respective UEs 104 via one or more radio frequency (RF) access links. In some implementations, the UE 104 may be simultaneously served by multiple RUs 440.

Each of the units, i.e., the CUS 410, the DUs 430, the RUs 440, as well as the near-RT RICs 425, the non-RT RICs 415 and the SMO framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., central unit-user plane (CU-UP)), control plane functionality (i.e., central unit-control plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the El interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a virtual RAN (vRAN) architecture.

The SMO Framework 405 may be configured to support RAN deployment and provisioning of non-virtualized and virtualized network elements. For non-virtualized network elements, the SMO framework 405 may be configured to support the deployment of dedicated physical resources for RAN coverage requirements, which may be managed via an operations and maintenance interface (such as an O1 interface). For virtualized network elements, the SMO framework 405 may be configured to interact with a cloud computing platform (such as an open cloud (O-cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and near-RT RICs 425. In some implementations, the SMO framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO framework 405 also may include the non-RT RIC 415 configured to support functionality of the SMO Framework 405.

The non-RT RIC 415 may be configured to include a logical function that enables non-real-time control and optimization of RAN elements and resources, artificial intelligence/machine learning (AI/ML) workflows including model training and updates, or policy-based guidance of applications/features in the near-RT RIC 425. The non-RT RIC 415 may be coupled to or communicate with (such as via an A1 interface) the near-RT RIC 425. The near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the near-RT RIC 425.

In some implementations, to generate AI/ML models to be deployed in the near-RT RIC 425, the non-RT RIC 415 may receive parameters or external enrichment information from external servers. Such information may be utilized by the near-RT RIC 425 and may be received at the SMO Framework 405 or the non-RT RIC 415 from non-network data sources or from network functions. In some examples, the non-RT RIC 415 or the near-RT RIC 425 may be configured to tune RAN behavior or performance. For example, the non-RT RIC 415 may monitor long-term trends and patterns for performance and employ AI/ML models to perform corrective actions through the SMO Framework 405 (such as reconfiguration via O1) or via creation of RAN management policies (such as A1 policies).

Uncrewed aerial vehicles (UAVs), also known as unmanned autonomous vehicles, have been used as base stations for emergency applications. UAVs have also been used as delivery vehicles for delivery of items from warehouses or between buildings.

For example, UAVs have been flown at altitudes between 100 and 200 meters, with coverage areas of approximately 6 square kilometers to over 100 square kilometers. Some of these UAVs are tethered such that the UAV can fly for extended periods and have fiber-optic or other data connections to ground stations. The UAV mobile base stations may also have satellite links for other communications channels.

However, these UAV base stations are operated by the network provider (e.g., of network 100), not by individuals or entities using the network for flight operations. In an aspect of the present disclosure, UAV operators may employ wireless network 100 for pre-flight preparations, inflight operation, flight mission applications, flight path recommendations, flight monitoring and control, and/or other operations for UAV monitoring and control.

In an aspect of the present disclosure, automatic routing for UAV for deliveries of goods may be possible. The UAV may be driven (flown) by the network 100 and the UAV (which may be a UE 104) route may be planned by the network 100. UAVs can be controlled to deliver at ground level or at altitude to upper floors of buildings.

In an aspect of the present disclosure, UAVs can be used to transfer supplies, food, medicines, etc., during lockdowns for health reasons. The UAVs can be controlled by the network 100, by UAV self-driving, by a UAV controller, or by some combination of network/self-driving/controller, as desired.

In an aspect of the present disclosure, UAV communications and UAV delivery can be combined. The network 100, via 3GPP or other protocols, may assist UAV auto-driving and/or auto routing for delivery services. Routing and flight management of the UAV can be performed by edge computing by a base station (e.g., a gNB), or an Access and Mobility Management Function (e.g., AMF 192, 193) within the network 100. The UAV route planning, delivery destination, delivery time, etc., as well as tracking during UAV travel, can also be performed by the network 100.

In an aspect of the present disclosure, the UAV route planning may support one or more UAV control modes. The UAV (which may be referred to as a UE 104 herein) may signal to the network 100 the UAV capabilities for mode support, e.g., whether the UAV can support a network controlled driving mode, a UAV auto-driving mode, a handheld controller driving mode, or a hybrid of the above modes. The network 100 can then communicate with the UAV information related to the UAV route, UAV operational mode (network controlled, auto-driving, controller driving, or hybrid mode), departure time, routing information, and/or other information about the UAV delivery route and timing. Network 100 operations can be done by base station 102, the AMF 192 or 193, the UPF 195, or a UAV route management server (URM) (which may be a other AMF 193 or UPF 195). A URM may also be referred to as an uncrewed aerial system traffic management server (UTM).

Information can be transmitted from and/or received at the UAV. Information that may originate from the UAV, or the entity operating the UAV via the IP services 176 and/or 197, may be delivery order information, UAV related information (license, capabilities, etc.). Information that may originate from the network 100 may include management functions, configuration related information, obstacle information, route planning, speeds through certain portions of the route, etc.

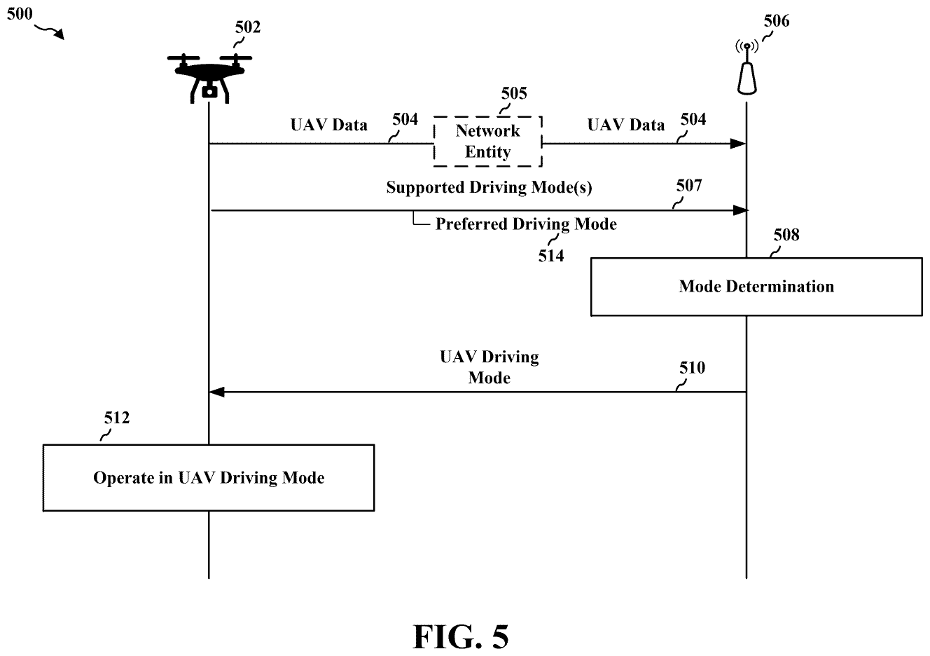

FIG. 5 illustrates a flow diagram of network communication in accordance with an aspect of the present disclosure.

Diagram 500 illustrates UAV 502 that sends UAV data 504 to a network entity 505 (which may be a server or application controlling the UAV, such as a URM server or a third-party server communicating with network 100). Network entity 505, in turn, may send the UAV data 504, or information associated with the UAV data 504, to network entity 506 (which may be base station 102/180). Alternatively, UAV 502 may send UAV data 504 directly to network entity 506. UAV data 504 may include communications channels for network 100 and/or network entity 506 to communicate with UAV 502, UAV 502 capabilities, driving modes supported by the UAV 502, a preferred driving mode for the UAV 502, or other UAV 502 specific information (e.g., unique identity (this may be a 3GPP identity), UE capability of the UAV, and the like) that provides support to the UAV for downlink communication and uplink communication with network entity 506.

UAV 502 may transmit a message including its supported driving mode(s) 507 to network entity 506. The message may be separate from UAV data 504 in this example, although in other examples, the supported driving mode(s) 507 may be part of UAV data 504. The driving modes which UAV 502 may support can include a network controlled driving mode, a UAV auto-driving mode, a handheld controller driving mode, a hybrid of the above modes, or a combination of any of the foregoing modes. Network entity 506, either alone or in conjunction with one or more other portions of network 100, e.g., AMF 192, AMF 193, UPF 195, etc., determines a driving mode for UAV 502, which may be referred to as the “decided mode” of UAV 502 operation in block 508, at least from the supported driving mode(s) 507. Network entity 506 then transmits the determined/decided UAV driving mode 510 message to the UAV 502. UAV 502 may then operate in the decided UAV driving mode 510 in block 512.

As part of UAV data 504 or the message including supported driving mode(s) 507, the user may provide a preferred driving mode 514 for the UAV 502. For example, and not by way of limitation, UAV data 504 or preferred driving mode 514 may include a preferred driving mode of UAV auto driving, controller driving, or network driving, or a hybrid mode of driving UAV 502 (e.g.,, one of the supported driving mode(s) 507). This may be provided to network entity 506 by UAV 502, or by an application communicating with network entity 506, e.g., via the IP services 176 and/or 197 (e.g., network entity 505). In an aspect of the present disclosure, UAV 502 may not report its supported driving mode(s) 507 and a preferred mode to network entity 506. In such an aspect, network entity 506 may provide a default mode of operation of UAV 502, e.g., a network-controlled mode or a UAV auto-driving mode, to UAV 502.

As part of UAV data 504, the message including supported driving mode(s) 507 and/or preferred driving mode 514, or a different message, UAV 502 may transmit other data, such as a time of departure of the UAV 502, a departure three dimensional (3D) location of the UAV 502, a destination 3D location of the UAV 502, a time of arrival of the UAV 502, a UAV 502 flight capability, a UAV 502 operator license, a UAV 502 mission type, a location of an obstacle in the planned route of the UAV 502, a real-time UAV 502 3D position, a UAV 502 heading, a UAV 502 velocity, a UAV 502 battery state, and/or a UAV 502 characteristic.

As part of mode determination block 508, network entity 506 may use a priority determination strategy, where the priority of operation of the UAV 502 may change based on UAV 502 destination, other UAV traffic, route geometry, QoS, or other factors. For example, network entity 506 may select to provide UAV 502 a network-controlled driving mode if any of the foregoing factors indicate that mode is higher priority than a UAV-controlled driving mode, or alternatively, network entity 506 may select to provide UAV 502 a UAV-controlled driving mode if any of the foregoing factors indicate that mode is higher priority than the network-controlled driving mode.

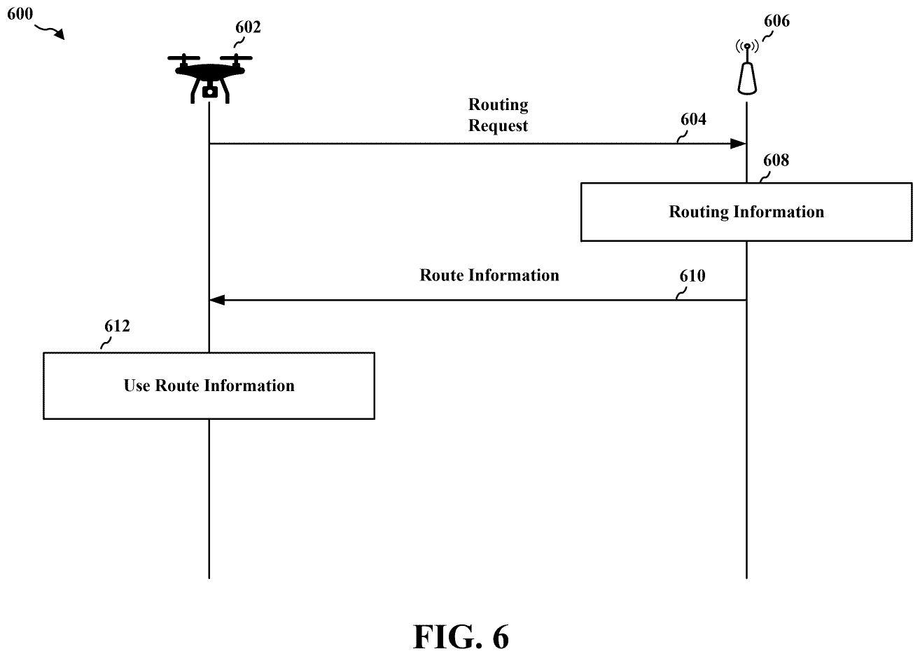

FIG. 6 illustrates a flow diagram of network communication in accordance with an aspect of the present disclosure.

Diagram 600 illustrates UAV 602 that sends a routing request 604 to a network entity 606 (which may be a base station, or a server or application controlling the UAV, such as a URM server or a third-party server communicating with network 100). Routing request 604 may include a 3D position of the UAV 602, time of departure and destination for the UAV 602, UAV 602 capabilities like support speed, operation license, mission priority, location of obstacles (as measured by UAV 602), real-time UAV 602 3D position, heading, velocity, battery state, communications channels for network 100 and/or network entity 606 to communicate with UAV 602, or other UAV 602 specific information. Diagram 600 illustrates an aspect of the present disclosure where network entity 606, or other portions of network 100, may determine that the UAV 602 is to be controlled by a network driving mode of operation.

In an aspect of the present disclosure, if the UAV 602 destination and timing (e.g., flight duration, destination delivery time, etc.) is indicated by the UAV 602 or the UAV application (controller), the UAV 602 or UAV controller may send route information (e.g., in routing request 604) to the network entity 606, which may be a base station 102. Depending on the destination of the UAV 602, i.e., whether the destination is in the coverage of the base station 102/network entity 606 or not, the network entity 606 may have different behaviors and/or responses to UAV 602 as shown by routing information 608. This route information 610 is then sent by the network entity 606 to UAV 602, which then uses the route information 610 in block 612 to operate the UAV 602.

In an aspect of the present disclosure, the UAV 602 may provide destination and timing information in routing request 604. Network entity 606 may use the provided destination and timing information in determining routing information 608, which may also be provided as route information 610 to the UAV 602. Alternatively, if the UAV 602 destination and timing is provided to network entity 606 (e.g., base station 102/180) from a different network entity (e.g., a URM server via an application on the server), rather than from the UAV 602 or UAV controller as in the previous example, the network entity 606 may provide the route information 610 to the UAV 602 (the UAV may download this information together with the route planning).

Route information 610 may also include other information regarding routing of UAV 602. For example, and not by way of limitation, route information 610 may include a routing path, a location-depend maximal allowed speed, a location-depend maximal allowed altitude along the route, an expected departure time, an expected arrival time, location of obstacles along the route as collected by network entity 606, and other information about the route that the UAV 602 may use. Further, the route information 610 may provide various levels of precision, e.g., meter-level to street-level, block-level, or labeled by network entity(e.g., network entity level, such as anchor gNB level or cell level), to provide altitude information or 3D position information of the route that the UAV 602 is to follow.

As part of routing request 604, UAV 602 may transmit other data, such as a time of departure of the UAV 602, a departure three dimensional (3D) location of the UAV 602, a destination 3D location of the UAV 602, a time of arrival of the UAV 602, a UAV 602 flight capability, a UAV 602 operator license, a UAV 602 mission type, a location of an obstacle in the planned route of the UAV 602, a real-time UAV 602 3D position, a UAV 602 heading, a UAV 602 velocity, a UAV 602 battery state, and/or a UAV 602 characteristic.

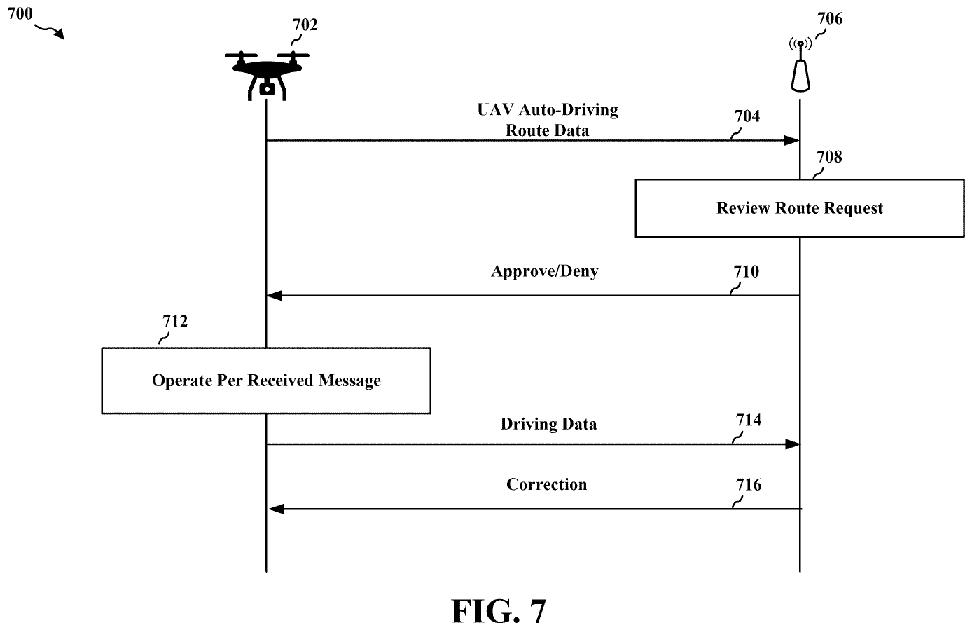

FIG. 7 illustrates a flow diagram of network communication in accordance with an aspect of the present disclosure.

Diagram 700 illustrates UAV 702 that sends UAV determined auto-driving route data 704 to a network entity 706 (which may be a base station, or a server or application controlling the UAV, such as a URM server or a third-party server communicating with network 100). Route data 704 may include a route calculated by the UAV 702 (or an application controlling the UAV 702), departure and destination positions and times, a UAV operation license, a mission priority, a real-time UAV 3D position, a heading, a velocity, a battery state, and/or other route-specific and/or UAV specific data (e.g., a reference position of the UAV). Diagram 700 illustrates an aspect of the present disclosure where UAV 702 may request a self-determined auto-driving mode of operation.

Network entity 706 reviews the route data 704 in block 708, and determines the appropriateness of the route data 704. Network entity 706, or another portion of network 100, replies with an approve/deny message 710 to the UAV 702. UAV 702 then operates per the received approve/deny message 710 in block 712.

If the approve/deny message 710 is an approval of the UAV route data 704, the UAV 702 may then operate as described in the UAV auto-driving route request. If the approve/deny message 710 is a denial of the UAV route data 704, the network entity 706 may indicate an alternative UAV 702 route, indicate that a network controlled driving mode for the UAV 702 should be used, or request that the UAV 702 calculate new route data for sending in another route data 704 message.

As part of flow diagram 700, the UAV 702 may send driving data 714, either by reporting UAV 702 position periodically to network entity 706, through position indication or sensing by network entity 706, via UAV 702 access to a particular base station 102 during flight, etc., to ensure that UAV 702 is on the approved route sent to the UAV in approve/deny message 710. For example, the UAV 702 transmit a geographic position of the UAV periodically to the network entity 706 during transit of the UAV on a planned route (e.g., via periodic 3D position reporting of the UAV 702 using, for example, a GPS). In another example, the UAV 702 may transmit a measurement of a reference signal to the network entity 706 during transit of the UAV on the planned route (e.g., via position indication via a CSI report or other measurement report including a measurement indicating a geographic position of the UAV). In another example, the UAV 702 may transmit a reference signal to the network entity during transit of the UAV on the planned route (e.g., via reflection of a received reference signal, where the network entity 706 may determine a geographic position of the UAV through sensing of this reflected reference signal). In another example, the UAV 702 may transmit cell information to the network entity during transit of the UAV on the planned route (e.g., cell information such as a cell ID for access to a particular base station, where the cell information may indicate to the network entity 706 a cell and thus a geographic position of the UAV). If the network entity determines from the geographic position information that the UAV 702 is not on the approved route, network entity 706 may send correction message 716 to UAV 702 (and/or to UAV controller and/or to a different network entity such as a URM server), which may redirect the UAV 702 to the correct route, redirect the UAV to an alternate route, instruct the UAV 702 to return to the point of departure, or provide other instructions.

As part of route data 704, or as part of driving data 714, UAV 702 may transmit other data, such as a time of departure of the UAV 702, a departure three dimensional (3D) location of the UAV 702, a destination 3D location of the UAV 702, a time of arrival of the UAV 702, a UAV 702 flight capability, a UAV 702 operator license, a UAV 702 mission type, a location of an obstacle in the planned route of the UAV 702, a real-time UAV 702 3D position, a UAV 702 heading, a UAV 702 velocity, a UAV 702 battery state, and/or a UAV 702 characteristic.

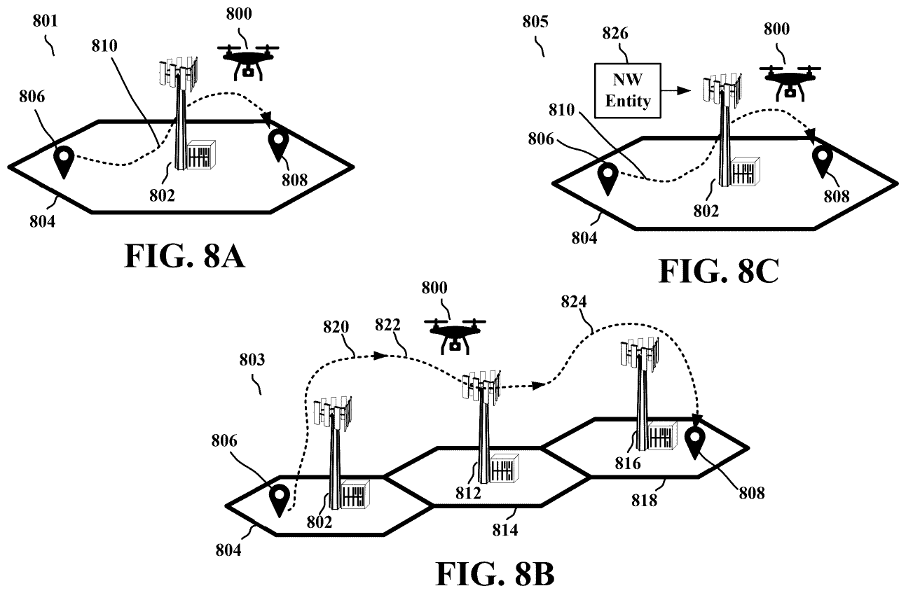

FIG. 8A illustrates network route planning in accordance with an aspect of the present disclosure. Diagram 801 illustrates an aspect of the present disclosure where a UAV 800 is to be controlled by a network driving mode of operation.

In an aspect of the present disclosure, the network 100, or some portion of the network 100, may plan a route for UAV 800. A base station 802, which may be similar to base station 102, may have a service area 804 or cell. If the departure point 806 and the destination 808 of the UAV 800 are in the service area 804 of base station 802, then base station 802 may perform route planning for route 810 of the UAV 800 (e.g., as previously described with respect to FIGS. 5-7 in connection with the network-controlled driving mode).

FIG. 8B illustrates network route planning in accordance with an aspect of the present disclosure. Diagram 803 illustrates an aspect of the present disclosure where a UAV 800 is to be controlled by a network driving mode of operation.

The route that UAV 800 may travel between departure point 806 and destination 808 may be in different service areas or cells. For example, and not by way of limitation, there may be multiple base stations, e.g., base station 802 having service area 804, base station 812 having service area 814, and base station 816 having service area 818 along the route for the UAV 800. If the departure point 806 and the destination 808 are in different service areas, and/or traverse multiple service areas, each base station may calculate part of the overall route for the UAV 800, or an anchor base station in a pool of base stations including base station 802, 812, 816 may calculate the overall route.

For example, and not bay way of limitation, base station 802 having service area 804 may calculate portion 820 of the overall route, base station 812 having service area 814 may calculate portion 822 of the overall route, and base station 816 having service area 818 may calculate portion 824 of the overall route of the UAV 800 between departure point 806 and destination 808. These base stations may respectively perform route planning for their respective route portion or segment, such as previously described with respect to FIGS. 5-7 in connection with the network-controlled driving mode.

FIG. 8C illustrates network route planning in accordance with an aspect of the present disclosure. Diagram 805 illustrates an aspect of the present disclosure where a UAV 800 is to be controlled by a network driving mode of operation.

In an aspect of the present disclosure, whether the departure point 806 and destination 808 are in the same service area 804 or not, a network entity 826 other than base station 802 (and/or base station 812, 816), which may be for example the AMF 192, 193, a URM server, or a Multi-Access Edge Cloud (MEC), may provide route calculations for UAV 800. In one aspect, if the network entity 826 may perform the route planning if its application provides the UAV destination and timing to base station 802, 812, 816. In another aspect, even if the destination 808 and/or UAV route timing may be indicated by the UAV 800 or the UAV controller (rather than by network entity 826), route 810 decisions and planning may remain under control of the network entity 826.

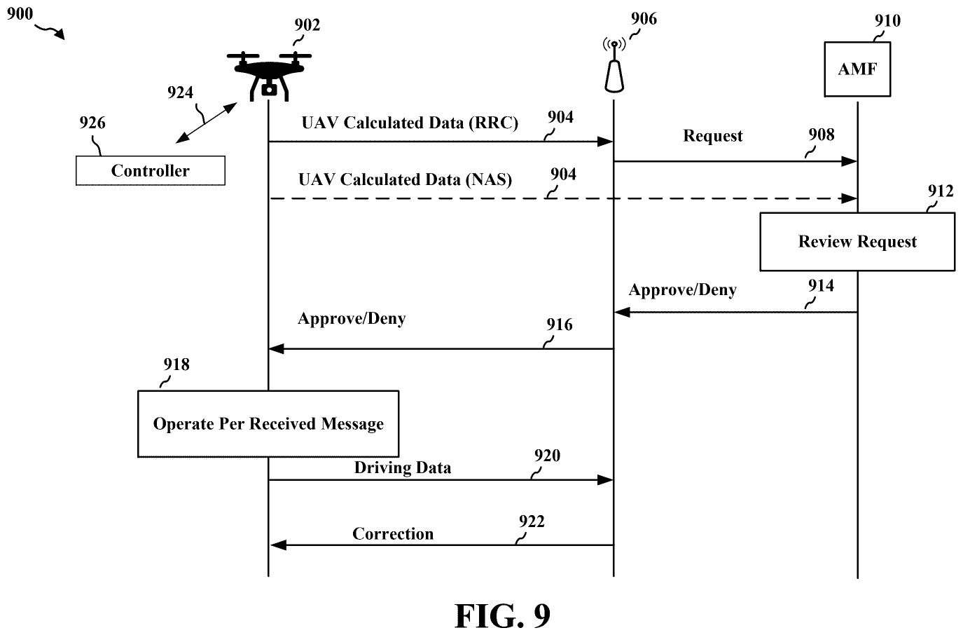

FIG. 9 illustrates a flow diagram of network communication in accordance with an aspect of the present disclosure.

In an aspect of the present disclosure, diagram 900 illustrates UAV 902 that sends UAV determined auto-driving route data 904 to a network entity 906 (which may be a base station, or a server or application controlling the UAV, such as a URM server or a third-party server communicating with network 100). For example, UAV 902 may provide route data 904 in an RRC message or configuration to network entity 906 (e.g., base station 102/180). Route data 904 may include a route calculated by the UAV 902 (or by an application controlling the UAV 902), departure and destination positions and times, a UAV operation license, a mission priority, a real-time UAV 3D position, a heading, a velocity, a battery state, and/or other route-specific and/or UAV specific data. Diagram 900 illustrates an aspect of the present disclosure where UAV 902 may request a self-determined auto-driving mode of operation, similar to the example of FIG. 7.

As part of UAV calculated route data 904, UAV 902 may calculate and propose a route planning to network entity 906. UAV calculated data 904 may be sent from UAV 902 via an RRC message or configuration to network entity 906. Alternatively, UAV 902 may send UAV calculated data 904 directly to AMF server 910 and/or another part of the network 100 via non-access stratum (NAS) signaling.

For instance, here, unlike the example of FIG. 7, here the network entity 906 may not be able to determine whether to approve or deny the UAV's requested route indicated in route data 904. For example, this case may be as in FIG. 8B, where the departure point 806 and destination 808 are in different cells, in which case base station 802 may not be able to approve/deny portions 822, 824 of the UAV's route, or this case may be as in FIG. 8C, where network entity 826 other than base station 802 performs the route calculations for the UAV 800. In such cases, network entity 906 may forward the UAV calculated route data 904 via a request 908 to AMF server 910 (or another network entity) to approve or deny. Alternatively, rather than UAV 902 sending route data 904 to network entity 906 via RRC as in this example, in another example, UAV 902 may send route data 904 directly via NAS signaling to AMF server 910 (or other network entity in EPC 160 or core network 190). AMF server 910 may be AMF 192, 193 or other server coupled to network entity 906 via network 100 or IP services 176 and/or IP services 197. Similar to network entity 706 in the example of FIG. 7, here AMF server 910 may review the route data 904 in block 912, and determine the appropriateness of the route data 904. AMF server 910 may then send an approve/deny message 914 to network entity 906.

In response to receiving approve/deny message 914 from AMF server 910 (or other network entity), network entity 906, or another portion of network 100, may then send an approve/deny message 916 to the UAV 902. Approve/deny message 916 may the same as approve/deny message 914 (i.e., network entity 906 may effectively relay the approve/deny message 914 to UAV 902). This example may apply in the case where UAV 902 sends route data 904 to network entity 906 via RRC signaling. In another example where UAV 902 sends route data 904 to AMF server 910 (or other network entity) via NAS signaling, AMF server 910 (or other network entity) may send approve/deny message 916 directly to UAV 902. In either case (RRC or NAS), UAV 902 then operates per the received approve/deny message 916 in block 918.

As part of UAV calculated data 904, UAV 902 may calculate and propose a route planning to network entity 906. UAV calculated data 904 may be sent from UAV 902 via an RRC message or configuration to network entity 906. Alternatively, UAV 902 may send UAV calculated data 904 directly to AMF server 910 and/or another part of the network 100 via NAS signaling.

While UAV 902 is flying, network entity 906 or AMF server 910 (or other network entity) may update or reconfigure the UAV calculated route data 904 to ensure the UAV 902 remains under network entity 906 and/or network 100 control. This process may be similar to that described with respect to FIG. 7 (e.g., if network entity 906 or AMF server 910 determines through periodic UAV position reporting, position indication or sensing, or base station cell information indication that UAV 902 deviated from its approved route, the UAV 902 have its route reconfigured and/or its mode switched to a network-controlled driving mode).

For instance, as part of flow diagram 900, the UAV 902 may send driving data 920, either by reporting UAV 902 position periodically to network entity 906, through position sensing by network entity 906, via UAV 902 access to a particular base station 102 during flight, etc., to ensure that UAV 902 is on the approved route sent to the UAV in approve/deny message 916. If the UAV 902 is not on the approved route, network entity 906 may send correction message 922 to UAV 902 (and/or UAV control server), which may redirect the UAV 902 to the correct route, an alternate route, for the UAV 902 to return to the point of departure, or other instructions.

If UAV 902 is being operated in a controller routing mode (a UAV controller driving mode), which may be via a handheld controller 926 for a given UAV 902, UAV 902 may be triggered to switch to a network-controlled driving mode or a UAV auto-driving mode, and thus to provide route data 904 to network entity 906 or AMF server 910 (or other network entity), based on one of various conditions. In one example, UAV 902 may sense that a command and control (C2) link 924 between UAV 902 and controller 926 has been lost for a period of time (a first condition) or that the C2 link has weakened (a second condition). For example, but not by way of limitation, a change in a characteristic of the C2 link may be sensed by UAV 902. Such a change in characteristic may be a loss in connection of the C2 link 924 for a threshold period of time (the first condition), a reference signal received power (RSRP) of a reference signal carried in the C2 link 924 being below a threshold (the second condition), or other changed characteristic of the C2 link 924. In another example, controller 926 may request a change of operational mode of UAV 902 (a third condition), either via UAV 902 or other connections to network entity 906. For instance, controller 926 (which may itself be a UE) may send a request (the third condition) to network entity 906 or to AMF server 910 (or other network entity) to switch UAV 902 to a network-controlled driving mode or a UAV auto-driving mode.

In an aspect of the present disclosure, UAV 902 and/or controller 926 may trigger an operational mode change of UAV 902 from controller 926 mode to network driving mode and/or UAV auto-driving mode. The change in operating mode can be triggered by the UAV 902, controller 926, or network entity 906, which may be based on UAV 902 report of C2 link 924 loss to network entity 906. For example, UAV 902 or UAV controller 926 may trigger the mode switching from a handheld controller driving mode to a network-controlled or UAV auto-controlled driving mode according to any of the foregoing conditions (e.g., the first, second, or third condition). In another example, UAV 902 may provide a measurement report of C2 link 924 to network entity 906, and if the measurement report indicates the C2 link is lost or sufficiently weakened (e.g., the first condition or the second condition), the network entity 906 may trigger the mode switching itself such as previously described with respect to FIG. 5. For instance, network entity 906 (e.g., network entity 506) may determine the mode at block 508 and send the UAV driving mode 510 to the UAV 502 to operate at block 512.

In an aspect of the present disclosure, when the switch of operational mode is triggered by UAV 902 or controller 926, UAV 902 or UAV controller 926 may send a request as UAV calculated route data 904 or other data to network entity 906. UAV 902 and/or controller 926 may then wait for a certain time window for the approve/deny message 916 (or other message) that provides new routing information to UAV 902 for network-controlled driving or approval of UAV 902 auto-driving information for UAV auto-controlled driving. Such a request may include the reason or conditions of the request (e.g., the first condition, second condition, or third condition), and may optionally further include a preferred mode of operation of UAV 902 (e.g., preferred driving mode 514 of FIG. 5). Network entity 906 may respond with operational mode of UAV 902 operation (e.g., UAV driving mode 510 of FIG. 5), routing configurations, and/or other data as part of the approve/deny 916 message (or other message).

As part of UAV calculated data 904, or as part of driving data 920, UAV 902 may transmit other data, such as a time of departure of the UAV 902, a departure three dimensional (3D) location of the UAV 902, a destination 3D location of the UAV 902, a time of arrival of the UAV 902, a UAV 902 flight capability, a UAV 902 operator license, a UAV 902 mission type, a location of an obstacle in the planned route of the UAV 902, a real-time UAV 902 3D position, a UAV 902 heading, a UAV 902 velocity, a UAV 902 battery state, and a UAV 902 characteristic.

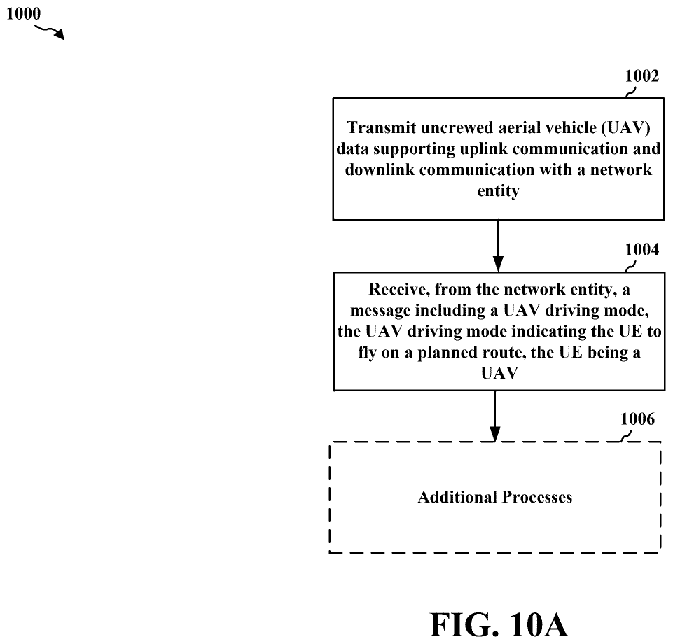

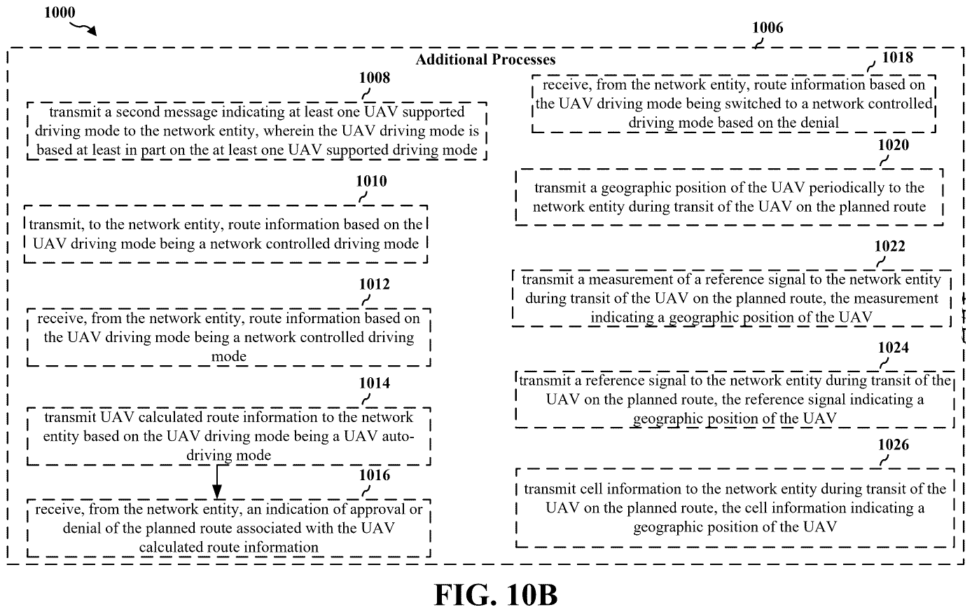

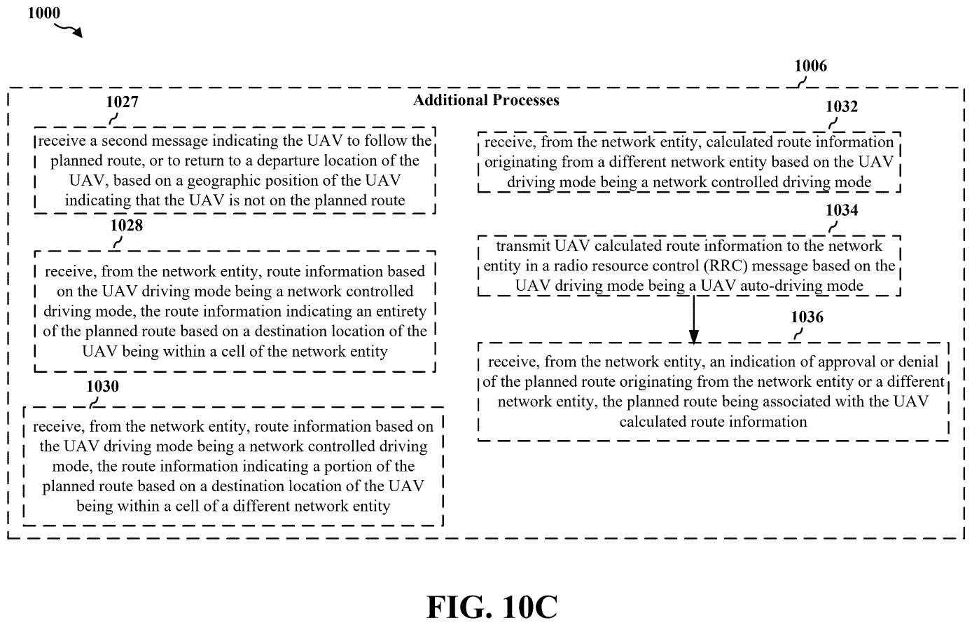

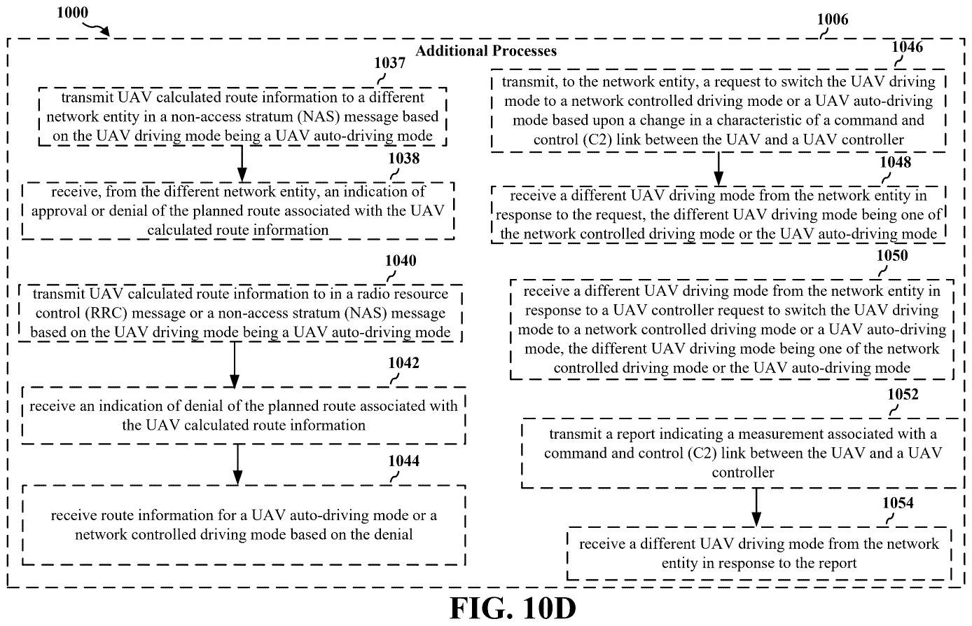

FIGS. 10A-10D is a flowchart 1000 of a method of wireless communication in accordance with an aspect of the present disclosure. The method may be performed by a UE (e.g., the UE 104, 350; the UAV 502, 602, 702, 800, 902 apparatus 1202). Optional aspects are illustrated in dashed lines.

Referring to FIG. 10A, at 1002, the UE transmits uncrewed aerial vehicle (UAV) data supporting uplink communication and downlink communication with a network entity. For example, 1002 may be performed by transmission component 1234.

At 1004, the UE receives, from the network entity, a message including a UAV driving mode, the UAV driving mode indicating the UE to fly on a planned route, the UE being a UAV. For example, 1004 may be performed by UAV data component 1240.

At 1006, additional processes may be undertaken by the UE. These processes are described with respect to FIGS. 10B-10D.

Referring to FIG. 10B, for example, at 1008, the UE may transmit a second message indicating at least one UAV supported driving mode to the network entity, wherein the UAV driving mode is based at least in part on the at least one UAV supported driving mode. In such an aspect, 1008 may be performed by transmission component 1234.

At 1010, as another example, the UE may transmit, to the network entity, route information based on the UAV driving mode being a network controlled driving mode, the route information including one or more of: a UAV position, a time of departure of the UAV, a departure location of the UAV, a destination location of the UAV, a time of arrival of the UAV, a UAV flight capability, a UAV operator license, a UAV mission type, a location of an obstacle in the planned route of the UAV, a real-time UAV three dimensional (3D) position, a UAV heading, a UAV velocity, a UAV battery state, and a UAV characteristic. In such an aspect, 1010 may be performed by transmission component 1234.

At 1012, as another example, the UE may receive, from the network entity, route information based on the UAV driving mode being a network controlled driving mode, the route information further being received based on a destination location of the UAV or an expected time of departure of the UAV originating from an application server in communication with the network entity. In such an aspect, 1012 may be performed by UAV data component 1240.

Additionally at 1012, as another example, the UE may receive, from the network entity, route information based on the UAV driving mode being a network controlled driving mode, the route information including one or more of a routing path for the UAV, a location dependent allowable speed of the UAV, a location dependent altitude of the UAV, an expected departure time of the UAV, an expected arrival time of the UAV, and a location of an obstacle in the planned route of the UAV. In such an aspect, 1012 may be performed by UAV data component 1240.

At 1014, as another example, the UE may transmit UAV calculated route information to the network entity based on the UAV driving mode being a UAV auto-driving mode, and at 1016, the UE may receive, from the network entity, an indication of approval or denial of the planned route associated with the UAV calculated route information. In such an aspect, 1014 and 1016 may be performed by transmission component 1234 and UAV data component 1240, respectively.

At 1018, as another example, the UE may receive, from the network entity, route information based on the UAV driving mode being switched to a network controlled driving mode based on the denial. In such an aspect, 1018 may be performed by UAV data component 1240.

At 1020, as another example, the UE may transmit a geographic position of the UAV periodically to the network entity during transit of the UAV on the planned route. In such an aspect, 1020 may be performed by transmission component 1234.

At 1022, as another example, the UE may transmit a measurement of a reference signal to the network entity during transit of the UAV on the planned route, the measurement indicating a geographic position of the UAV. In such an aspect, 1022 may be performed by transmission component 1234.

At 1024, as another example, the UE may transmit a reference signal to the network entity during transit of the UAV on the planned route, the reference signal indicating a geographic position of the UAV. In such an aspect, 1024 may be performed by transmission component 1234.

At 1026, as another example, the UE may transmit cell information to the network entity during transit of the UAV on the planned route, the cell information indicating a geographic position of the UAV. In such an aspect, 1026 may be performed by transmission component 1234.

Referring to FIG. 10C, as another example, at 1027, the UE may receive a second message indicating the UAV to follow the planned route, or to return to a departure location of the UAV, based on a geographic position of the UAV indicating that the UAV is not on the planned route. In such an aspect, 1027 may be performed by UAV data component 1240.

At 1028, as another example, the UE may receive, from the network entity, route information based on the UAV driving mode being a network controlled driving mode, the route information indicating an entirety of the planned route based on a destination location of the UAV being within a cell of the network entity. In such an aspect, 1028 may be performed by UAV data component 1240.

At 1030, as another example, the UE may receive, from the network entity, route information based on the UAV driving mode being a network controlled driving mode, the route information indicating a portion of the planned route based on a destination location of the UAV being within a cell of a different network entity. In such an aspect, 1030 may be performed by UAV data component 1240.

At 1032, as another example, the UE may receive, from the network entity, calculated route information originating from a different network entity based on the UAV driving mode being a network controlled driving mode. In such an aspect, 1032 may be performed by UAV data component 1240.

At 1034, as another example, the UE may transmit UAV calculated route information to the network entity in a radio resource control (RRC) message based on the UAV driving mode being a UAV auto-driving mode, and at 1036, the UE may receive, from the network entity, an indication of approval or denial of the planned route originating from a different network entity, the planned route being associated with the UAV calculated route information. In such an aspect, 1034 and 1036 may be performed by transmission component 1234 and UAV data component 1240, respectively.

Referring to FIG. 10D, at 1037, as another example, the UE may transmit UAV calculated route information to a different network entity in a non-access stratum (NAS) message based on the UAV driving mode being a UAV auto-driving mode, and at 1038, the UE may receive, from the different network entity, an indication of approval or denial of the planned route associated with the UAV calculated route information. In such an aspect, 1037 and 1038 may be performed by transmission component 1234 and UAV data component 1240, respectively.

At 1040, as another example, the UE may transmit UAV calculated route information in a radio resource control (RRC) message or a non-access stratum (NAS) message based on the UAV driving mode being a UAV auto-driving mode, at 1042, the UE may receive an indication of denial of the planned route associated with the UAV calculated route information, and at 1044, the UE may receive route information for a UAV auto-driving mode or a network controlled driving mode based on the denial. In such an aspect, 1040 may be performed by transmission component 1234 and 1042 and 1044 may be performed by UAV data component 1240.

At 1046, as another example, the UE may transmit, to the network entity, a request to switch the UAV driving mode to a network controlled driving mode or a UAV auto-driving mode based upon a change in a characteristic of a command and control (C2) link between the UAV and a UAV controller, and at 1048, the UE may receive a different UAV driving mode from the network entity in response to the request, the different UAV driving mode being one of the network controlled driving mode or the UAV auto-driving mode. In such an aspect, 1046 and 1048 may be performed by transmission component 1234 and UAV data component 1240, respectively.

At 1050, as another example, the UE may receive a different UAV driving mode from the network entity in response to a UAV controller request to switch the UAV driving mode to a network controlled driving mode or a UAV auto-driving mode, the different UAV driving mode being one of the network controlled driving mode or the UAV auto-driving mode. In such an aspect, 1050 may be performed by UAV data component 1240.

At 1052, as another example, the UE may transmit a report indicating a measurement associated with a command and control (C2) link between the UAV and a UAV controller, and at 1054, the UE may receive a different UAV driving mode from the network entity in response to the report. In such an aspect, 1052 and 1054 may be performed by transmission component 1234 and UAV data component 1240, respectively.

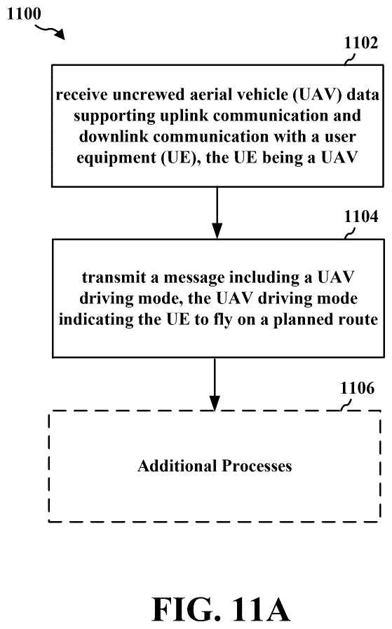

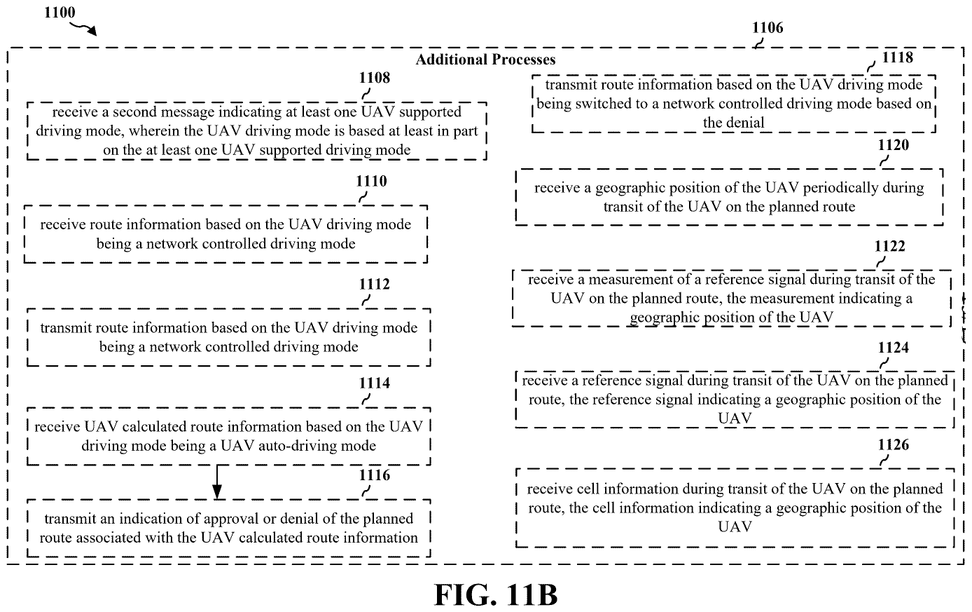

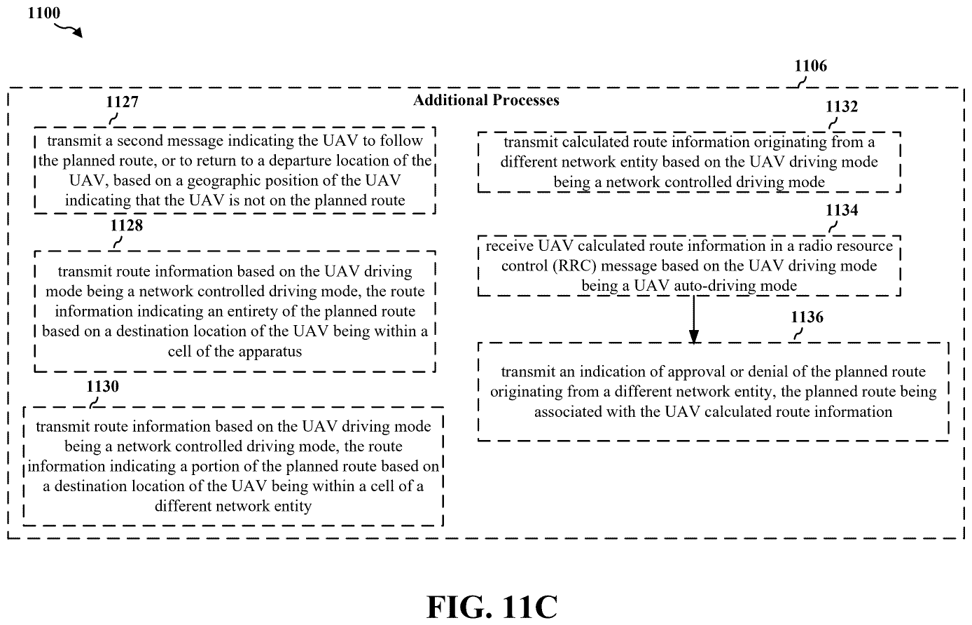

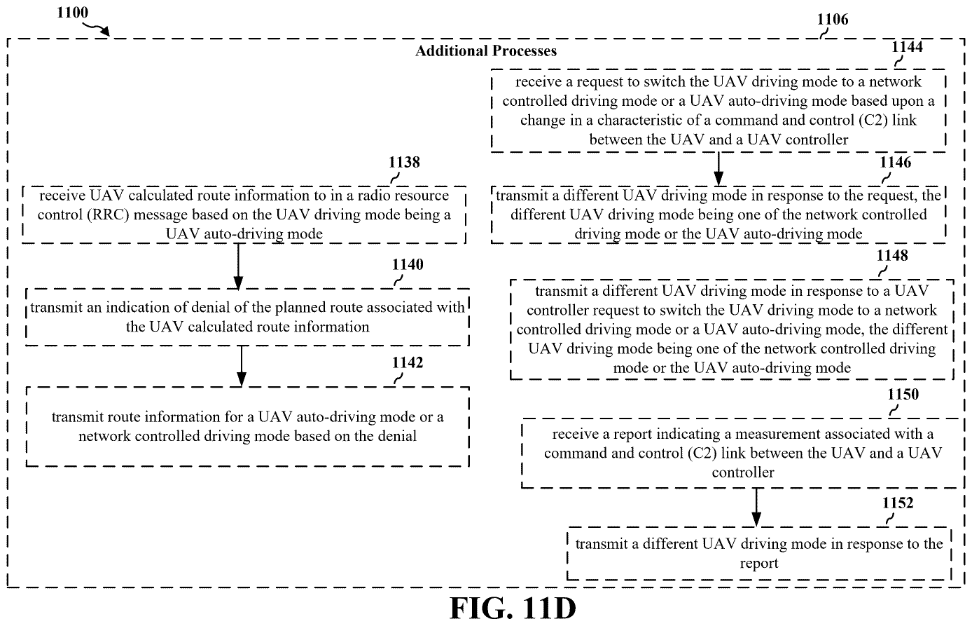

FIGS. 11A-11D is a flowchart 1100 of a method of wireless communication. The method may be performed by a network entity (e.g., the base station 102/180, 310; network entity 506, 606, 706, 802, 812, 816, 906, apparatus 1302). Optional aspects are illustrated in dashed lines. While the following description refers specifically to a base station as the network entity, it should be understood that a different network entity than the base station (e.g., an AMF, URM server, MEC server, etc.) may perform one or more of the following steps.

At 1102, the base station receives uncrewed aerial vehicle (UAV) data supporting uplink communication and downlink communication with a UE, the UE being a UAV. For example, 1102 may be performed by UAV data component 1340.

At 1104, the base station transmits a message including a UAV driving mode, the UAV driving mode indicating the UE to fly on a planned route. For example, 1104 may be performed by transmission component 1334.

At 1106, additional processes may be undertaken by the base station. These processes are described with respect to FIGS. 11B-11D.

Referring to FIG. 11B, at 1108, for example, the base station may receive a second message indicating at least one UAV supported driving mode to the network entity, wherein the UAV driving mode is based at least in part on the at least one UAV supported driving mode. In such an aspect, 1108 may be performed by UAV data component 1340.

At 1110, as another example, the base station may receive route information based on the UAV driving mode being a network controlled driving mode, the route information including one or more of: a UAV position, a time of departure of the UAV, a departure location of the UAV, a destination location of the UAV, a time of arrival of the UAV, a UAV flight capability, a UAV operator license, a UAV mission type, a location of an obstacle in the planned route of the UAV, a real-time UAV three dimensional (3D) position, a UAV heading, a UAV velocity, a UA V battery state, and a UAV characteristic. In such an aspect, 1110 may be performed by UAV data component 1340.

At 1112, as another example, the base station may transmit route information based on the UAV driving mode being a network controlled driving mode, the route information further being transmitted based on a destination location of the UAV or an expected time of departure of the UAV originating from an application server in communication with the network entity. In such an aspect, 1112 may be performed by transmission component 1334.

Also at 1112, as another example, the base station may transmit route information based on the UAV driving mode being a network controlled driving mode, the route information including one or more of a routing path for the UAV, a location dependent allowable speed of the UAV, a location dependent altitude of the UAV, an expected departure time of the UAV, an expected arrival time of the UAV, and a location of an obstacle in the planned route of the UAV. In such an aspect, 1106 may be performed by transmission component 1334.

At 1114, as another example, the base station may receive UAV calculated route information based on the UAV driving mode being a UAV auto-driving mode, and at 1116, the base station may transmit an indication of approval or denial of the planned route associated with the UAV calculated route information. In such an aspect, 1114 and 1116 respectively may be performed by UAV data component 1340 and transmission component 1334.

At 1118, as another example, the base station may transmit route information based on the UAV driving mode being switched to a network controlled driving mode based on the denial. In such an aspect, 1118 may be performed by transmission component 1334.

At 1120, as another example, the base station may receive a geographic position of the UAV periodically during transit of the UAV on the planned route. In such an aspect, 1120 may be performed by UAV data component 1340.

At 1122, as another example, the base station may receive a measurement of a reference signal during transit of the UAV on the planned route, the measurement indicating a geographic position of the UAV. In such an aspect, 1122 may be performed by UAV data component 1340.

At 1124, as another example, the base station may receive a reference signal during transit of the UAV on the planned route, the reference signal indicating a geographic position of the UAV. In such an aspect, 1124 may be performed by UAV data component 1340.

At 1126, as another example, the base station may receive cell information during transit of the UAV on the planned route, the cell information indicating a geographic position of the UAV. In such an aspect, 1126 may be performed by UAV data component 1340.

Referring to FIG. 11C, at 1127, as another example, the base station may transmit a second message indicating the UAV to follow the planned route, or to return to a departure location of the UAV, based on a geographic position of the UAV indicating that the UAV is not on the planned route. In such an aspect, 1127 may be performed by transmission component 1334.

At 1128, as another example, the base station may transmit route information based on the UAV driving mode being a network controlled driving mode, the route information indicating an entirety of the planned route based on a destination location of the UAV being within a cell of the network entity. In such an aspect, 1128 may be performed by transmission component 1334.

At 1130, as another example, the base station may transmit route information based on the UAV driving mode being a network controlled driving mode, the route information indicating a portion of the planned route based on a destination location of the UAV being within a cell of a different network entity. In such an aspect, 1130 may be performed by transmission component 1334.

At 1132, as another example, the base station may transmit calculated route information originating from a different network entity based on the UAV driving mode being a network controlled driving mode. In such an aspect, 1132 may be performed by transmission component 1334.

At 1134, as another example, the base station may receive UAV calculated route information in a radio resource control (RRC) message based on the UAV driving mode being a UAV auto-driving mode, and at 1136, the base station may transmit an indication of approval or denial of the planned route originating from a different network entity, the planned route being associated with the UAV calculated route information. In such an aspect, 1134 and 1136 may be performed respectively by UAV data component 1340 and transmission component 1334.

Referring to FIG. 11D, at 1138, as another example, the base station may receive UAV calculated route information to in a radio resource control (RRC) message based on the UAV driving mode being a UAV auto-driving mode, at 1140, the base station may transmit an indication of denial of the planned route associated with the UAV calculated route information, and at 1142, the base station may transmit route information for a UAV auto-driving mode or a network controlled driving mode based on the denial. In such an aspect, 1138, 1140, and 1142 may be performed respectively by UAV data component 1340 and transmission component 1334.

At 1144, as another example, the base station may receive a request to switch the UAV driving mode to a network controlled driving mode or a UAV auto-driving mode based upon a change in a characteristic of a command and control (C2) link between the UAV and a UAV controller, and at 1146, the base station may transmit a different UAV driving mode in response to the request, the different UAV driving mode being one of the network controlled driving mode or the UAV auto-driving mode. In such an aspect, 1144 and 1146 may be performed respectively by UAV data component 1340 and transmission component 1334.

At 1148, as another example, the base station may transmit a different UAV driving mode in response to a UAV controller request to switch the UAV driving mode to a network controlled driving mode or a UAV auto-driving mode, the different UAV driving mode being one of the network controlled driving mode or the UAV auto-driving mode. In such an aspect, 1148 may be performed by transmission component 1334.

At 1150, as another example, the base station may receive a report indicating a measurement associated with a command and control (C2) link between the UAV and a UAV controller, and at 1152, the base station may transmit a different UAV driving mode in response to the report. In such an aspect, 1150 and 1152 may be performed respectively by UAV data component 1340 and transmission component 1334.

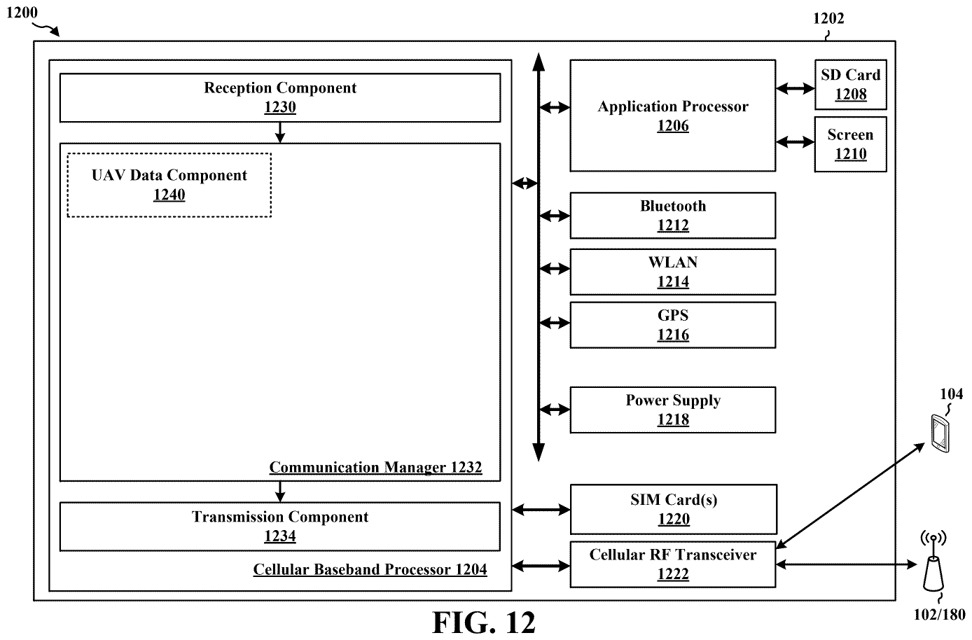

FIG. 12 is a diagram 1200 illustrating an example of a hardware implementation for an apparatus 1202. The apparatus 1202 is a UE and includes a cellular baseband processor 1204 (also referred to as a modem) coupled to a cellular RF transceiver 1222 and one or more subscriber identity modules (SIM) cards 1220, an application processor 1206 coupled to a secure digital (SD) card 1208 and a screen 1210, a Bluetooth module 1212, a wireless local area network (WLAN) module 1214, a Global Positioning System (GPS) module 1216, and a power supply 1218. The cellular baseband processor 1204 communicates through the cellular RF transceiver 1222 with the UE 104 and/or BS 102/180. The cellular baseband processor 1204 may include a computer-readable medium/memory. The computer-readable medium / memory may be non-transitory. The cellular baseband processor 1204 is responsible for general processing, including the execution of software stored on the computer-readable medium/memory. The software, when executed by the cellular baseband processor 1204, causes the cellular baseband processor 1204 to perform the various functions described supra. The computer-readable medium/memory may also be used for storing data that is manipulated by the cellular baseband processor 1204 when executing software. The cellular baseband processor 1204 further includes a reception component 1230, a communication manager 1232, and a transmission component 1234. The communication manager 1232 includes the one or more illustrated components. The components within the communication manager 1232 may be stored in the computer-readable medium/memory and/or configured as hardware within the cellular baseband processor 1204. The cellular baseband processor 1204 may be a component of the UE 350 and may include the memory 360 and/or at least one of the TX processor 368, the RX processor 356, and the controller/processor 359. In one configuration, the apparatus 1202 may be a modem chip and include just the baseband processor 1204, and in another configuration, the apparatus 1202 may be the entire UE (e.g., see 350 of FIG. 3) and include the aforediscussed additional modules of the apparatus 1202.

The communication manager 1232 includes a UAV data component 1240 that is configured to receive a message including a UAV driving mode, the UAV driving mode indicating the UE to fly on a planned route, the UE being a UAV, e.g., as described in connection with 1004.

Transmission component 1234 may transmit a second message indicating at least one UAV supported driving mode to the network entity, wherein the UAV driving mode is based at least in part on the at least one UAV supported driving mode, as described with respect to 1008.

Transmission component 1234 may transmit, to the network entity, route information based on the UAV driving mode being a network controlled driving mode, the route information including one or more of: a UAV position, a time of departure of the UAV, a departure location of the UAV, a destination location of the UAV, a time of arrival of the UAV, a UAV flight capability, a UAV operator license, a UAV mission type, a location of an obstacle in the planned route of the UAV, a real-time UAV three dimensional (3D) position, a UAV heading, a UAV velocity, a UAV battery state, and a UAV characteristic, as described with respect to 1010.

UAV data component 1240 may receive, from the network entity, route information based on the UAV driving mode being a network controlled driving mode, the route information further being received based on a destination location of the UAV or an expected time of departure of the UAV originating from an application server in communication with the network entity, as described with respect to 1012.

UAV data component 1240 may receive, from the network entity, route information based on the UAV driving mode being a network controlled driving mode, the route information including one or more of a routing path for the UAV, a location dependent allowable speed of the UAV, a location dependent altitude of the UAV, an expected departure time of the UAV, an expected arrival time of the UAV, and a location of an obstacle in the planned route of the UAV, as described with respect to 1012.

Transmission component 1234 may transmit UAV calculated route information to the network entity based on the UAV driving mode being a UAV auto-driving mode, and UAV data component 1240 may receive, from the network entity, an indication of approval or denial of the planned route associated with the UAV calculated route information, as described with respect to 1014 and 1016, respectively.

UAV data component 1240 may receive, from the network entity, route information based on the UAV driving mode being switched to a network controlled driving mode based on the denial, as described with respect to 1018

Transmission component 1234 may transmit a geographic position of the UAV periodically to the network entity during transit of the UAV on the planned route. as described with respect to 1020.

Transmission component 1234 may transmit a measurement of a reference signal to the network entity during transit of the UAV on the planned route, the measurement indicating a geographic position of the UAV, as described with respect to 1022.

Transmission component 1234 may transmit a reference signal to the network entity during transit of the UAV on the planned route, the reference signal indicating a geographic position of the UAV, as described with respect to 1024.

Transmission component 1234 may transmit cell information to the network entity during transit of the UAV on the planned route, the cell information indicating a geographic position of the UAV, as described with respect to 1026.

UAV data component 1240 may receive a second message indicating the UAV to follow the planned route, or to return to a departure location of the UAV, based on a geographic position of the UAV indicating that the UAV is not on the planned route, as described with respect to 1027.

UAV data component 1240 may receive, from the network entity, route information based on the UAV driving mode being a network controlled driving mode, the route information indicating an entirety of the planned route based on a destination location of the UAV being within a cell of the network entity, as described with respect to 1028.

UAV data component 1240 may receive, from the network entity, route information based on the UAV driving mode being a network controlled driving mode, the route information indicating a portion of the planned route based on a destination location of the UAV being within a cell of a different network entity, as described with respect to 1030.

UAV data component 1240 may receive, from the network entity, calculated route information originating from a different network entity based on the UAV driving mode being a network controlled driving mode, as described with respect to 1032.

Transmission component 1234 may transmit UAV calculated route information to the network entity in a radio resource control (RRC) message based on the UAV driving mode being a UAV auto-driving mode, and UAV data component 1240 the UE may receive, from the network entity, an indication of approval or denial of the planned route originating from a different network entity, the planned route being associated with the UAV calculated route information, as described by 1034 and 1036 respectively.

Transmission component 1234 may transmit UAV calculated route information to a different network entity in a non-access stratum (NAS) message based on the UAV driving mode being a UAV auto-driving mode, and UAV data component 1240 may receive, from the different network entity, an indication of approval or denial of the planned route associated with the UAV calculated route information, as described by 1037 and 1038, respectively.

Transmission component 1234 may transmit UAV calculated route information in a radio resource control (RRC) message or a non-access stratum (NAS) message based on the UAV driving mode being a UA V auto-driving mode, and UAV data component 1240 may receive an indication of denial of the planned route associated with the UAV calculated route information, and UAV data component 1240 may receive route information for a UAV auto-driving mode or a network controlled driving mode based on the denial, as described by 1040, 1042 and 1044, respectively.

Transmission component 1234 may transmit, to the network entity, a request to switch the UAV driving mode to a network controlled driving mode or a UAV auto-driving mode based upon a change in a characteristic of a command and control (C2) link between the UAV and a UAV controller, and UAV data component 1240 may receive a different UAV driving mode from the network entity in response to the request, the different UAV driving mode being one of the network controlled driving mode or the UAV auto-driving mode, as described by 1046 and 1048, respectively.

UAV data component 1240 may receive a different UAV driving mode from the network entity in response to a UAV controller request to switch the UAV driving mode to a network controlled driving mode or a UAV auto-driving mode, the different UAV driving mode being one of the network controlled driving mode or the UAV auto-driving mode, as described by 1050.

Transmission component 1234 may transmit a report indicating a measurement associated with a command and control (C2) link between the UAV and a UAV controller, and UAV data component 1240 may receive a different UAV driving mode from the network entity in response to the report, as described by 1052 and 1054 respectively.

The apparatus may include additional components that perform each of the blocks of the algorithm in the aforementioned flowcharts of FIGS. 10A-10D. As such, each block in the aforementioned flowcharts of FIGS. 10A-10D may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1202, and in particular the cellular baseband processor 1204, includes means for transmitting uncrewed aerial vehicle (UAV) data supporting uplink communication and downlink communication with a network entity, and means for receiving, from the network entity, a message including a UAV driving mode, the UAV driving mode indicating the apparatus to fly on a planned route, the apparatus being a UAV.

In one configuration, the apparatus 1202, and in particular the cellular baseband processor 1204, includes means for transmitting a second message indicating at least one UAV supported driving mode to the network entity, wherein the UAV driving mode is based at least in part on the at least one UAV supported driving mode.

In one configuration, the apparatus 1202, and in particular the cellular baseband processor 1204, includes means for transmitting, to the network entity, route information based on the UAV driving mode being a network controlled driving mode, the route information including one or more of: a UAV position, a time of departure of the UAV, a departure location of the UAV, a destination location of the UAV, a time of arrival of the UAV, a UAV flight capability, a UAV operator license, a UAV mission type, a location of an obstacle in the planned route of the UAV, a real-time UAV three dimensional (3D) position, a UAV heading, a UAV velocity, a UAV battery state, and a UAV characteristic.

In one configuration, the apparatus 1202, and in particular the cellular baseband processor 1204, includes means for receiving, from the network entity, route information based on the UAV driving mode being a network controlled driving mode, the route information further being received based on a destination location of the UAV or an expected time of departure of the UAV originating from an application server in communication with the network entity.

In one configuration, the apparatus 1202, and in particular the cellular baseband processor 1204, includes means for receiving, from the network entity, route information based on the UAV driving mode being a network controlled driving mode, the route information including one or more of a routing path for the UAV, a location dependent allowable speed of the UAV, a location dependent altitude of the UAV, an expected departure time of the UAV, an expected arrival time of the UAV, and a location of an obstacle in the planned route of the UAV.

In one configuration, the apparatus 1202, and in particular the cellular baseband processor 1204, includes means for transmitting UAV calculated route information to the network entity based on the UAV driving mode being a UAV auto-driving mode, and means for receiving, from the network entity, an indication of approval or denial of the planned route associated with the UAV calculated route information.

In one configuration, the apparatus 1202, and in particular the cellular baseband processor 1204, includes means for receiving, from the network entity, route information based on the UAV driving mode being switched to a network controlled driving mode based on the denial.

In one configuration, the apparatus 1202, and in particular the cellular baseband processor 1204, includes means for transmitting a geographic position of the UAV periodically to the network entity during transit of the UAV on the planned route.

In one configuration, the apparatus 1202, and in particular the cellular baseband processor 1204, includes means for transmitting a measurement of a reference signal to the network entity during transit of the UAV on the planned route, the measurement indicating a geographic position of the UAV.

In one configuration, the apparatus 1202, and in particular the cellular baseband processor 1204, includes means for transmitting a reference signal to the network entity during transit of the UAV on the planned route, the reference signal indicating a geographic position of the UAV.

In one configuration, the apparatus 1202, and in particular the cellular baseband processor 1204, includes means for transmitting cell information to the network entity during transit of the UAV on the planned route, the cell information indicating a geographic position of the UAV.

In one configuration, the apparatus 1202, and in particular the cellular baseband processor 1204 includes means for receiving a second message indicating the UAV to follow the planned route, or to return to a departure location of the UAV, based on a geographic position of the UAV indicating that the UAV is not on the planned route.

In one configuration, the apparatus 1202, and in particular the cellular baseband processor 1204, includes means for receiving, from the network entity, route information based on the UAV driving mode being a network controlled driving mode, the route information indicating an entirety of the planned route based on a destination location of the UAV being within a cell of the network entity.

In one configuration, the apparatus 1202, and in particular the cellular baseband processor 1204, includes means for receiving, from the network entity, route information based on the UAV driving mode being a network controlled driving mode, the route information indicating a portion of the planned route based on a destination location of the UAV being within a cell of a different network entity.

In one configuration, the apparatus 1202, and in particular the cellular baseband processor 1204, includes means for receiving, from the network entity, calculated route information originating from a different network entity based on the UAV driving mode being a network controlled driving mode.

In one configuration, the apparatus 1202, and in particular the cellular baseband processor 1204, includes means for transmitting UAV calculated route information to the network entity in a radio resource control (RRC) message based on the UAV driving mode being a UAV auto-driving mode, and means for receiving, from the network entity, an indication of approval or denial of the planned route originating from a different network entity, the planned route being associated with the UAV calculated route information.

In one configuration, the apparatus 1202, and in particular the cellular baseband processor 1204, includes means for transmitting UAV calculated route information to a different network entity in a non-access stratum (NAS) message based on the UAV driving mode being a UAV auto-driving mode, and means for receiving, from the different network entity, an indication of approval or denial of the planned route associated with the UAV calculated route information.

In one configuration, the apparatus 1202, and in particular the cellular baseband processor 1204, includes means for transmitting UAV calculated route information in a radio resource control (RRC) message or a non-access stratum (NAS) message based on the UAV driving mode being a UAV auto-driving mode, means for receiving an indication of denial of the planned route associated with the UAV calculated route information, and means for receiving route information for a UAV auto-driving mode or a network controlled driving mode based on the denial.

In one configuration, the apparatus 1202, and in particular the cellular baseband processor 1204, includes means for transmitting, to the network entity, a request to switch the UAV driving mode to a network controlled driving mode or a UAV auto-driving mode based upon a change in a characteristic of a command and control (C2) link between the UAV and a UAV controller, and means for receiving a different UAV driving mode from the network entity in response to the request, the different UAV driving mode being one of the network controlled driving mode or the UAV auto-driving mode.

In one configuration, the apparatus 1202, and in particular the cellular baseband processor 1204, includes means for receiving a different UAV driving mode from the network entity in response to a UAV controller request to switch the UAV driving mode to a network controlled driving mode or a UAV auto-driving mode, the different UAV driving mode being one of the network controlled driving mode or the UAV auto-driving mode.

In one configuration, the apparatus 1202, and in particular the cellular baseband processor 1204, includes means for transmitting a report indicating a measurement associated with a command and control (C2) link between the UAV and a UAV controller, and means for receiving a different UAV driving mode from the network entity in response to the report.

The aforementioned means may be one or more of the aforementioned components of the apparatus 1202 configured to perform the functions recited by the aforementioned means. As described supra, the apparatus 1202 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

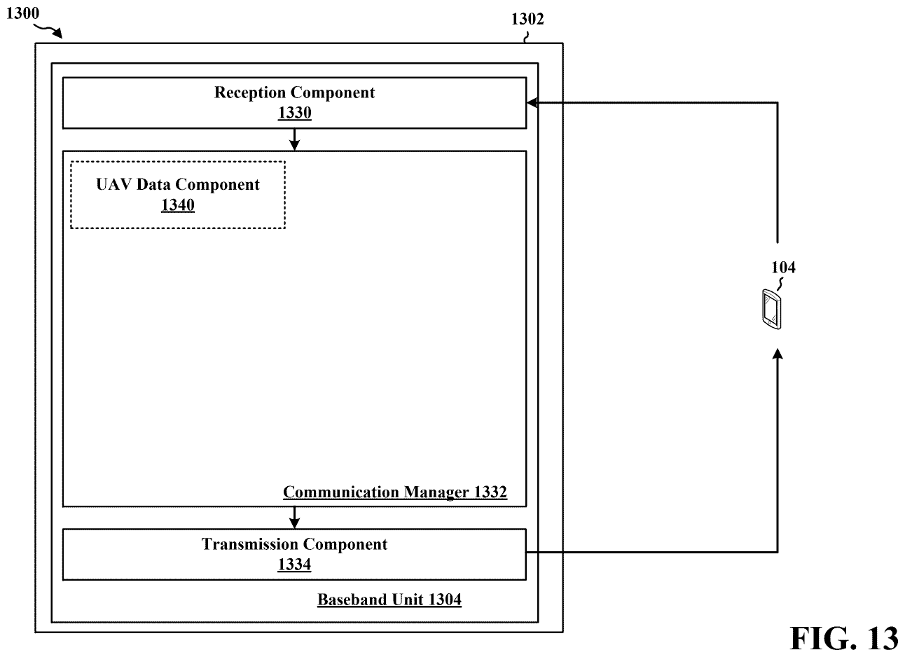

FIG. 13 is a diagram 1300 illustrating an example of a hardware implementation for an apparatus 1302. The apparatus 1302 is a BS and includes a baseband unit 1304. The baseband unit 1304 may communicate through a cellular RF transceiver with the UE 104. The baseband unit 1304 may include a computer-readable medium/memory. The baseband unit 1304 is responsible for general processing, including the execution of software stored on the computer-readable medium/memory. The software, when executed by the baseband unit 1304, causes the baseband unit 1304 to perform the various functions described supra. The computer-readable medium/memory may also be used for storing data that is manipulated by the baseband unit 1304 when executing software. The baseband unit 1304 further includes a reception component 1330, a communication manager 1332, and a transmission component 1334. The communication manager 1332 includes the one or more illustrated components. The components within the communication manager 1332 may be stored in the computer-readable medium/memory and/or configured as hardware within the baseband unit 1304. The baseband unit 1304 may be a component of the BS 310 and may include the memory 376 and/or at least one of the TX processor 316, the RX processor 370, and the controller/processor 375.

The communication manager 1332 includes a UAV data component 1340 that receives uncrewed aerial vehicle (UAV) data supporting uplink communication and downlink communication with a user equipment (UE), the UE being a UAV, e.g., as described in connection with 1102.

UAV data component 1340 may receive a second message indicating at least one UAV supported driving mode to the network entity, wherein the UAV driving mode is based at least in part on the at least one UAV supported driving mode, as described with respect to 1108.

UAV data component 1340 may receive route information based on the UAV driving mode being a network controlled driving mode, the route information including one or more of: a UAV position, a time of departure of the UAV, a departure location of the UAV, a destination location of the UAV, a time of arrival of the UAV, a UAV flight capability, a UAV operator license, a UAV mission type, a location of an obstacle in the planned route of the UAV, a real-time UAV three dimensional (3D) position, a UAV heading, a UAV velocity, a UAV battery state, and a UAV characteristic, as described with respect to 1110.

Transmission component 1334 may transmit route information based on the UAV driving mode being a network controlled driving mode, the route information further being transmitted based on a destination location of the UAV or an expected time of departure of the UAV originating from an application server in communication with the network entity, as described with respect to 1112.

Transmission component 1334 may transmit route information based on the UAV driving mode being a network controlled driving mode, the route information including one or more of a routing path for the UAV, a location dependent allowable speed of the UAV, a location dependent altitude of the UAV, an expected departure time of the UAV, an expected arrival time of the UAV, and a location of an obstacle in the planned route of the UAV, as described with respect to 1112.

UAV data component 1340 may receive UAV calculated route information based on the UAV driving mode being a UAV auto-driving mode, and transmission component 1334 may transmit an indication of approval or denial of the planned route associated with the UAV calculated route information, as described with respect to 1114 and 1116 respectively.

Transmission component 1334 may transmit route information based on the UAV driving mode being switched to a network controlled driving mode based on the denial as described with respect to 1118.

UAV data component 1340 may receive a geographic position of the UAV periodically during transit of the UAV on the planned route as described with respect to 1120.

UAV data component 1340 may receive a measurement of a reference signal during transit of the UAV on the planned route, the measurement indicating a geographic position of the UAV as described with respect to 1122.

UAV data component 1340 may receive a reference signal during transit of the UAV on the planned route, the reference signal indicating a geographic position of the UAV as described with respect to 1124.

UAV data component 1340 may receive cell information during transit of the UAV on the planned route, the cell information indicating a geographic position of the UAV as described with respect to 1126.

Transmission component 1334 may transmit a second message indicating the UAV to follow the planned route, or to return to a departure location of the UAV, based on a geographic position of the UAV indicating that the UAV is not on the planned route as described with respect to 1127.

Transmission component 1334 may transmit route information based on the UAV driving mode being a network controlled driving mode, the route information indicating an entirety of the planned route based on a destination location of the UAV being within a cell of the network entity as described with respect to 1128.

Transmission component 1334 may transmit route information based on the UAV driving mode being a network controlled driving mode, the route information indicating a portion of the planned route based on a destination location of the UAV being within a cell of a different network entity as described with respect to 1130.

Transmission component 1334 may transmit calculated route information originating from a different network entity based on the UAV driving mode being a network controlled driving mode as described with respect to 1132.

UAV data component 1340 may receive UAV calculated route information in a radio resource control (RRC) message based on the UAV driving mode being a UAV auto-driving mode, and transmission component 1334 may transmit an indication of approval or denial of the planned route originating from a different network entity, the planned route being associated with the UAV calculated route information, as described by UAV data component 1340 and transmission component 1334 respectively.

UAV data component 1340 may receive UAV calculated route information to in a radio resource control (RRC) message based on the UAV driving mode being a UAV auto-driving mode, transmission component 1334 may transmit an indication of denial of the planned route associated with the UAV calculated route information, and transmission component 1334 may transmit route information for a UAV auto-driving mode or a network controlled driving mode based on the denial, as described by 1138, 1140, and 1142 respectively.

UAV data component 1340 may receive a request to switch the UAV driving mode to a network controlled driving mode or a UAV auto-driving mode based upon a change in a characteristic of a command and control (C2) link between the UAV and a UAV controller, and transmission component 1334 may transmit a different UAV driving mode in response to the request, the different UAV driving mode being one of the network controlled driving mode or the UAV auto-driving mode, as described by 1144 and 1146 respectively.

Transmission component 1334 may transmit a different UAV driving mode in response to a UAV controller request to switch the UAV driving mode to a network controlled driving mode or a UAV auto-driving mode, the different UAV driving mode being one of the network controlled driving mode or the UAV auto-driving mode as described by 1148.

UAV data component 1340 may receive a report indicating a measurement associated with a command and control (C2) link between the UAV and a UAV controller, and transmission component 1334 may transmit a different UAV driving mode in response to the report as described by 1150 and 1152 respectively.

The apparatus may include additional components that perform each of the blocks of the algorithm in the aforementioned flowcharts of FIGS. 11A-11D. As such, each block in the aforementioned flowcharts of FIGS. 11A-11D may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1302, and in particular the baseband unit 1304, includes means for means for receiving uncrewed aerial vehicle (UAV) data supporting uplink communication and downlink communication with a user equipment (UE), the UE being a UAV, means for transmitting a message including a UAV driving mode, the UAV driving mode indicating the UE to fly on a planned route.

In one configuration, the apparatus 1302, and in particular the cellular baseband processor 1304, includes means for UAV data component 1340 may receive a second message indicating at least one UAV supported driving mode to the network entity, wherein the UAV driving mode is based at least in part on the at least one UAV supported driving mode.

In one configuration, the apparatus 1302, and in particular the cellular baseband processor 1304, includes means for receive route information based on the UAV driving mode being a network controlled driving mode, the route information including one or more of: a UAV position, a time of departure of the UAV, a departure location of the UAV, a destination location of the UAV, a time of arrival of the UAV, a UAV flight capability, a UAV operator license, a UAV mission type, a location of an obstacle in the planned route of the UAV, a real-time UAV three dimensional (3D) position, a UAV heading, a UAV velocity, a UAV battery state, and a UAV characteristic.

In one configuration, the apparatus 1302, and in particular the cellular baseband processor 1304, includes means for transmitting route information based on the UAV driving mode being a network controlled driving mode, the route information further being transmitted based on a destination location of the UAV or an expected time of departure of the UAV originating from an application server in communication with the network entity.

In one configuration, the apparatus 1302, and in particular the cellular baseband processor 1304, includes means for transmitting route information based on the UAV driving mode being a network controlled driving mode, the route information including one or more of a routing path for the UAV, a location dependent allowable speed of the UAV, a location dependent altitude of the UAV, an expected departure time of the UAV, an expected arrival time of the UAV, and a location of an obstacle in the planned route of the UAV.

In one configuration, the apparatus 1302, and in particular the cellular baseband processor 1304, includes means for receiving UAV calculated route information based on the UAV driving mode being a UAV auto-driving mode, and means for transmitting an indication of approval or denial of the planned route associated with the UAV calculated route information.

In one configuration, the apparatus 1302, and in particular the cellular baseband processor 1304, includes means for transmitting route information based on the UAV driving mode being switched to a network controlled driving mode based on the denial.

In one configuration, the apparatus 1302, and in particular the cellular baseband processor 1304, includes means for receiving a geographic position of the UAV periodically during transit of the UAV on the planned route.

In one configuration, the apparatus 1302, and in particular the cellular baseband processor 1304, includes means for receiving a measurement of a reference signal during transit of the UAV on the planned route, the measurement indicating a geographic position of the UAV.

In one configuration, the apparatus 1302, and in particular the cellular baseband processor 1304, includes means for receiving a reference signal during transit of the UAV on the planned route, the reference signal indicating a geographic position of the UAV.

In one configuration, the apparatus 1302, and in particular the cellular baseband processor 1304, includes means for receiving cell information during transit of the UAV on the planned route, the cell information indicating a geographic position of the UAV.

In one configuration, the apparatus 1302, and in particular the cellular baseband processor 1304, includes means for transmitting a second message indicating the UAV to follow the planned route, or to return to a departure location of the UAV, based on a geographic position of the UAV indicating that the UAV is not on the planned route.

In one configuration, the apparatus 1302, and in particular the cellular baseband processor 1304, includes means for transmitting route information based on the UAV driving mode being a network controlled driving mode, the route information indicating an entirety of the planned route based on a destination location of the UAV being within a cell of the network entity.

In one configuration, the apparatus 1302, and in particular the cellular baseband processor 1304, includes means for transmitting route information based on the UAV driving mode being a network controlled driving mode, the route information indicating a portion of the planned route based on a destination location of the UAV being within a cell of a different network entity.

In one configuration, the apparatus 1302, and in particular the cellular baseband processor 1304, includes means for transmitting calculated route information originating from a different network entity based on the UAV driving mode being a network controlled driving mode.

In one configuration, the apparatus 1302, and in particular the cellular baseband processor 1304, includes means for receiving UAV calculated route information in a radio resource control (RRC) message based on the UAV driving mode being a UAV auto-driving mode, and means for transmitting an indication of approval or denial of the planned route originating from a different network entity, the planned route being associated with the UAV calculated route information.

In one configuration, the apparatus 1302, and in particular the cellular baseband processor 1304, includes means for receiving UAV calculated route information to in a radio resource control (RRC) message based on the UAV driving mode being a UAV auto-driving mode, means for transmitting an indication of denial of the planned route associated with the UAV calculated route information, and means for transmitting route information for a UAV auto-driving mode or a network controlled driving mode based on the denial.

In one configuration, the apparatus 1302, and in particular the cellular baseband processor 1304, includes means for receiving a request to switch the UAV driving mode to a network controlled driving mode or a UAV auto-driving mode based upon a change in a characteristic of a command and control (C2) link between the UAV and a UAV controller, and means for transmitting a different UAV driving mode in response to the request, the different UAV driving mode being one of the network controlled driving mode or the UAV auto-driving mode.

In one configuration, the apparatus 1302, and in particular the cellular baseband processor 1304, includes means for transmitting a different UAV driving mode in response to a UAV controller request to switch the UAV driving mode to a network controlled driving mode or a UAV auto-driving mode, the different UAV driving mode being one of the network controlled driving mode or the UAV auto-driving mode.

In one configuration, the apparatus 1302, and in particular the cellular baseband processor 1304, includes means for receiving a report indicating a measurement associated with a command and control (C2) link between the UAV and a UAV controller, and transmission component 1334 may transmit a different UAV driving mode in response to the report.

The aforementioned means may be one or more of the aforementioned components of the apparatus 1302 configured to perform the functions recited by the aforementioned means. As described supra, the apparatus 1302 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

The present disclosure provides a managed, regulated use of airspace and flight operations/configurations for UAVs. Route management, operational mode, emergency overrides, and network control of UAV routing and operations are possible within the scope of the present disclosure.

Further disclosure is included in the Appendix.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following examples are illustrative only and may be combined with aspects of other embodiments or teachings described herein, without limitation.

Example 1 is an apparatus for wireless communication, including: a memory; and at least one processor coupled to the memory and configured to: transmit uncrewed aerial vehicle (UAV) data supporting uplink communication and downlink communication with a network entity; and receive, from the network entity, a message including a UAV driving mode, the UAV driving mode indicating the apparatus to fly on a planned route, the apparatus being a UAV.

Example 2 is the apparatus of Example 1, wherein the at least one processor is further configured to: transmit a second message indicating at least one UAV supported driving mode to the network entity, wherein the UAV driving mode is based at least in part on the at least one UAV supported driving mode.

Example 3 is the apparatus of Example 2, wherein the second message further indicates a UAV preferred driving mode, wherein the UAV driving mode is the UAV preferred driving mode.

Example 4 is the apparatus of Examples 2 or 3, wherein the at least one processor is further configured to: transmit, to the network entity, route information based on the UAV driving mode being a network controlled driving mode, the route information including one or more of: a time of departure of the UAV, a departure three dimensional (3D) location of the UAV, a destination 3D location of the UAV, a time of arrival of the UAV, a UAV flight capability, a UAV operator license, a UAV mission type, a location of an obstacle in the planned route of the UAV, a real-time UAV 3D position, a UAV heading, a UAV velocity, a UAV battery state, and a UAV characteristic.

Example 5 is the apparatus of Examples 2 or 3, wherein the at least one processor is further configured to: receive, from the network entity, route information based on the UAV driving mode being a network controlled driving mode, the route information further being received based on a destination location of the UAV or an expected time of departure of the UAV originating from an application server in communication with the network entity.

Example 6 is the apparatus of any of Examples 1 to 3, wherein the at least one processor is further configured to: receive, from the network entity, route information based on the UAV driving mode being a network controlled driving mode, the route information including one or more of a routing path for the UAV, a location dependent allowable speed of the UAV, a location dependent allowable altitude of the UAV, an expected departure time of the UAV, an expected arrival time of the UAV, and a location of an obstacle in the planned route of the UAV.

Example 7 is the apparatus of any of Examples 1 to 6, wherein the planned route is associated with a route path precision based on the UAV driving mode being a network controlled driving mode, the route path precision being meter level, street level, block level, or network entity level.

Example 8 is the apparatus of any of Examples 1 to 7, wherein the UAV driving mode is based at least in part on one or more of a UAV destination, a quality of service (QoS) of the uplink communication or the downlink communication, a geometry of the planned route, and UAV traffic in the planned route.

Example 9 is the apparatus of any of Examples 1 to 3, wherein the at least one processor is further configured to: transmit UAV calculated route information to the network entity based on the UAV driving mode being a UAV auto-driving mode; and receive, from the network entity, an indication of approval or denial of the planned route associated with the UAV calculated route information.

Example 10 is the apparatus of Example 9, wherein the UAV calculated route information includes one or more of: a UAV position, a time of departure of the UAV, a departure 3D location of the UAV, a destination 3D location of the UAV, a time of arrival of the UAV, a UAV flight capability, a UAV operator license, a UAV mission type, a location of an obstacle in the planned route of the UAV, a real-time UAV three dimensional (3D) position, a UAV heading, a UAV velocity, a UAV battery state, and a UAV characteristic.

Example 11 is the apparatus of Examples 9 or 10, wherein the at least one processor is further configured to: receive, from the network entity, route information based on the UAV driving mode being switched to a network controlled driving mode based on the denial.

Example 12 is the apparatus of any of Examples 1 to 3 and 9 to 11, wherein the at least one processor is further configured to: transmit a geographic position of the UAV periodically to the network entity during transit of the UAV on the planned route.

Example 13 is the apparatus any of Examples 1 to 3 and 9 to 12, wherein the at least one processor is further configured to: transmit a measurement of a reference signal to the network entity during transit of the UAV on the planned route, the measurement indicating a geographic position of the UAV.

Example 14 is the apparatus of any of Examples 1 to 3 and 9 to 13, wherein the at least one processor is further configured to: transmit a reference signal to the network entity during transit of the UAV on the planned route, the reference signal indicating a geographic position of the UAV.

Example 15 is the apparatus of any of Examples 1 to 3 and 9 to 14, wherein the at least one processor is further configured to: transmit cell information to the network entity during transit of the UAV on the planned route, the cell information indicating a geographic position of the UAV.

Example 16 is the apparatus of any of Examples 1 to 3 and 9 to 15, wherein the at least one processor is further configured to: receive a second message indicating the UAV to follow the planned route, or to return to a departure location of the UAV, based on a geographic position of the UAV indicating that the UAV is not on the planned route.

Example 17 is the apparatus of any of Examples 1 to 3 and 9 to 16, wherein the UAV driving mode is one of: a UAV auto-driving mode, a network controlled driving mode, a UAV controller driving mode, or a combination of at least two of the UAV auto-driving mode, the network controlled driving mode, and the UAV controller driving mode.

Example 18 is the apparatus of any of Examples 1 to 8 and 17, wherein the at least one processor is further configured to: receive, from the network entity, route information based on the UAV driving mode being a network controlled driving mode, the route information indicating an entirety of the planned route based on a destination location of the UAV being within a cell of the network entity.

Example 19 is the apparatus of any of Examples 1 to 8 and 17, wherein the at least one processor is further configured to: receive, from the network entity, route information based on the UAV driving mode being a network controlled driving mode, the route information indicating a portion of the planned route based on a destination location of the UAV being within a cell of a different network entity.

Example 20 is the apparatus of any of Examples 1 to 8 and 17, wherein the at least one processor is further configured to: receive, from the network entity, calculated route information originating from a different network entity based on the UAV driving mode being a network controlled driving mode.

Example 21 is the apparatus of any of Examples 1 to 3 and 9 to 17, wherein the at least one processor is further configured to: transmit UAV calculated route information to the network entity in a radio resource control (RRC) message based on the UAV driving mode being a UAV auto-driving mode; and receive, from the network entity, an indication of approval or denial of the planned route originating from the network entity or a different network entity, the planned route being associated with the UAV calculated route information.

Example 22 is the apparatus of any of Examples 1 to 3 and 9 to 17, wherein the at least one processor is further configured to: transmit UAV calculated route information to a different network entity in a non-access stratum (NAS) message based on the UAV driving mode being a UAV auto-driving mode; and receive, from the different network entity, an indication of approval or denial of the planned route associated with the UAV calculated route information.

Example 23 is the apparatus of any of Examples 1 to 3, 9 to 17, 21, and 22, wherein the at least one processor is further configured to: transmit UAV calculated route information to in a radio resource control (RRC) message or a non-access stratum (NAS) message based on the UAV driving mode being a UAV auto-driving mode; receive an indication of denial of the planned route associated with the UAV calculated route information; and receive route information for a UAV auto-driving mode or a network controlled driving mode based on the denial.

Example 24 is the apparatus of any of Examples 1 to 3 and 17, wherein the UAV driving mode is a UAV controller driving mode, and wherein the at least one processor is further configured to: transmit, to the network entity, a request to switch the UAV driving mode to a network controlled driving mode or a UAV auto-driving mode based upon a change in a characteristic of a command and control (C2) link between the UAV and a UAV controller; and receive a different UAV driving mode from the network entity in response to the request, the different UAV driving mode being one of the network controlled driving mode or the UAV auto-driving mode.

Example 25 is the apparatus of Example 24, wherein the change in the characteristic of the C2 link is a loss in connection of the C2 link.

Example 26 is the apparatus of Example 24, wherein the change in the characteristic of the C2 link is a reference signal received power (RSRP) of a reference signal carried in the C2 link being lower than a threshold.

Example 27 is the apparatus of any of Examples 24 to 26, wherein the request indicates the change in the characteristic of the C2 link.

Example 28 is the apparatus of any of Examples 24 to 27, wherein the request further indicates a UAV preferred driving mode.

Example 29 is the apparatus of any of Examples 1 to 3 and 17, wherein the UAV driving mode is a UAV controller driving mode, and wherein the at least one processor is further configured to: receive a different UAV driving mode from the network entity in response to a UAV controller request to switch the UAV driving mode to a network controlled driving mode or a UAV auto-driving mode, the different UAV driving mode being one of the network controlled driving mode or the UAV auto-driving mode.

Example 30 is the apparatus of any of Examples 1 to 3 and 17, wherein the UAV driving mode is a UAV controller driving mode, and wherein the at least one processor is further configured to: transmit a report indicating a measurement associated with a command and control (C2) link between the UAV and a UAV controller; and receive a different UAV driving mode from the network entity in response to the report.

Example 31 is the apparatus of any of Examples 1 to 30, wherein the network entity is a base station.

Example 32 is a method of wireless communication at a user equipment (UE) comprising the steps performed by the apparatus of any of Examples 1 to 31.

Example 33 is an apparatus for wireless communication, including: means for transmitting uncrewed aerial vehicle (UAV) data supporting uplink communication and downlink communication with a network entity; and means for receiving, from the network entity, a message including a UAV driving mode, the UAV driving mode indicating the apparatus to fly on a planned route, the apparatus being a UAV.

Example 34 is a non-transitory computer-readable medium storing computer executable code, the code when executed by a processor cause the processor to: transmit uncrewed aerial vehicle (UAV) data supporting uplink communication and downlink communication with a network entity; and receive, from the network entity, a message including a UAV driving mode, the UAV driving mode indicating an apparatus to fly on a planned route, the apparatus being a UAV.

Example 35 is an apparatus for wireless communication, including: a memory; and at least one processor coupled to the memory and configured to: receive uncrewed aerial vehicle (UAV) data supporting uplink communication and downlink communication with a user equipment (UE), the UE being a UAV; and transmit a message including a UAV driving mode, the UAV driving mode indicating the UE to fly on a planned route.

Example 36 is the apparatus of Example 35, wherein the at least one processor is further configured to: receive a second message indicating at least one UAV supported driving mode, wherein the UAV driving mode is based at least in part on the at least one UAV supported driving mode.

Example 37 is the apparatus of Example 36, wherein the second message further indicates a UAV preferred driving mode, wherein the UAV driving mode is the UAV preferred driving mode.

Example 38 is the apparatus of Examples 36 or 37, wherein the at least one processor is further configured to: receive route information based on the UAV driving mode being a network controlled driving mode, the route information including one or more of: a UAV position, a time of departure of the UAV, a departure location of the UAV, a destination location of the UAV, a time of arrival of the UAV, a UAV flight capability, a UAV operator license, a UAV mission type, a location of an obstacle in the planned route of the UAV, a real-time UAV three dimensional (3D) position, a UAV heading, a UAV velocity, a UAV battery state, and a UAV characteristic.

Example 39 is the apparatus of Examples 36 or 37, wherein the at least one processor is further configured to: transmit route information based on the UAV driving mode being a network controlled driving mode, the route information further being transmitted based on a destination location of the UAV or an expected time of departure of the UAV originating from an application server in communication with the apparatus.

Example 40 is the apparatus of any of Examples 35 to 37, wherein the at least one processor is further configured to: transmit route information based on the UAV driving mode being a network controlled driving mode, the route information including one or more of a routing path for the UAV, a location dependent allowable speed of the UAV, a location dependent altitude of the UAV, an expected departure time of the UAV, an expected arrival time of the UAV, and a location of an obstacle in the planned route of the UAV.

Example 41 is the apparatus of any of Examples 35 to 40, wherein the planned route is associated with a route path precision based on the UAV driving mode being a network controlled driving mode, the route path precision being meter level, street level, block level, or network entity level.

Example 42 is the apparatus of any of Examples 35 to 41, wherein the UAV driving mode is based at least in part on one or more of a UAV destination, a quality of service (QoS) of the uplink communication or the downlink communication, a geometry of the planned route, and UAV traffic in the planned route.

Example 43 is the apparatus of any of Examples 35 to 37, wherein the at least one processor is further configured to: receive UAV calculated route information based on the UAV driving mode being a UAV auto-driving mode; and transmit an indication of approval or denial of the planned route associated with the UAV calculated route information.

Example 44 is the apparatus of Example 43, wherein the UAV calculated route information includes one or more of: a UAV position, a time of departure of the UAV, a departure location of the UAV, a destination location of the UAV, a time of arrival of the UAV, a UAV flight capability, a UAV operator license, a UAV mission type, a location of an obstacle in the planned route of the UAV, a real-time UAV three dimensional (3D) position, a UAV heading, a UAV velocity, a UA V battery state, and a UAV characteristic.

Example 45 is the apparatus of Example 43 or 44, wherein the at least one processor is further configured to: transmit route information based on the UAV driving mode being switched to a network controlled driving mode based on the denial.

Example 46 is the apparatus of any of Examples 35 to 37 and 43 to 45, wherein the at least one processor is further configured to: receive a geographic position of the UAV periodically during transit of the UAV on the planned route.

Example 47 is the apparatus of any of Examples 35 to 37 and 43 to 46, wherein the at least one processor is further configured to: receive a measurement of a reference signal during transit of the UAV on the planned route, the measurement indicating a geographic position of the UAV.

Example 48 is the apparatus of any of Examples 35 to 37 and 43 to 47, wherein the at least one processor is further configured to: receive a reference signal during transit of the UAV on the planned route, the reference signal indicating a geographic position of the UAV.

Example 49 is the apparatus of any of Examples 35 to 37 and 43 to 48, wherein the at least one processor is further configured to: receive cell information during transit of the UAV on the planned route, the cell information indicating a geographic position of the UAV.

Example 50 is the apparatus of any of Examples 35 to 37 and 43 to 49, wherein the at least one processor is further configured to: transmit a second message indicating the UAV to follow the planned route, or to return to a departure location of the UAV, based on a geographic position of the UAV indicating that the UAV is not on the planned route.

Example 51 is the apparatus of any of Examples 35 to 37 and 43 to 50, wherein the UAV driving mode is one of: a UAV auto-driving mode, a network controlled driving mode, a UAV controller driving mode, or a combination of at least two of the UAV auto-driving mode, the network controlled driving mode, and the UAV controller driving mode.

Example 52 is the apparatus of Examples 35 to 42 and 51, wherein the at least one processor is further configured to: transmit route information based on the UAV driving mode being a network controlled driving mode, the route information indicating an entirety of the planned route based on a destination location of the UAV being within a cell of the apparatus.

Example 53 is the apparatus of Examples 35 to 42 and 51, wherein the apparatus is a network entity, and wherein the at least one processor is further configured to: transmit route information based on the UAV driving mode being a network controlled driving mode, the route information indicating a portion of the planned route based on a destination location of the UAV being within a cell of a different network entity.

Example 54 is the apparatus of Examples 35 to 42 and 51, wherein the apparatus is a network entity, and wherein the at least one processor is further configured to: transmit calculated route information originating from a different network entity based on the UAV driving mode being a network controlled driving mode.

Example 55 is the apparatus of any of Examples 35 to 37 and 43 to 51, wherein the apparatus is a network entity, and wherein the at least one processor is further configured to: receive UAV calculated route information in a radio resource control (RRC) message based on the UAV driving mode being a UAV auto-driving mode; and transmit an indication of approval or denial of the planned route originating from a different network entity, the planned route being associated with the UAV calculated route information.

Example 56 is the apparatus of any of Examples 35 to 37, 43 to 51, and 55, wherein the at least one processor is further configured to: receive UAV calculated route information to in a radio resource control (RRC) message based on the UAV driving mode being a UAV auto-driving mode; transmit an indication of denial of the planned route associated with the UAV calculated route information; and transmit route information for a UAV auto-driving mode or a network controlled driving mode based on the denial.

Example 57 is the apparatus of any of Examples 35 to 37 and 51, wherein the UAV driving mode is a UAV controller driving mode, and wherein the at least one processor is further configured to: receive a request to switch the UAV driving mode to a network controlled driving mode or a UAV auto-driving mode based upon a change in a characteristic of a command and control (C2) link between the UAV and a UAV controller; and transmit a different UAV driving mode in response to the request, the different UAV driving mode being one of the network controlled driving mode or the UAV auto-driving mode.

Example 58 is the apparatus of Example 57, wherein the change in the characteristic of the C2 link is a loss in connection of the C2 link.

Example 59 is the apparatus of Example 57, wherein the change in the characteristic of the C2 link is a reference signal received power (RSRP) of a reference signal carried in the C2 link being lower than a threshold.

Example 60 is the apparatus of any of Examples 57 to 59, wherein the request indicates the change in the characteristic of the C2 link.

Example 61 is the apparatus of any of Examples 57 to 60, wherein the request further indicates a UAV preferred driving mode.

Example 62 is the apparatus of any of Examples 35 to 37 and 51, wherein the UAV driving mode is a UAV controller driving mode, and wherein the at least one processor is further configured to: transmit a different UAV driving mode in response to a UAV controller request to switch the UAV driving mode to a network controlled driving mode or a UAV auto-driving mode, the different UAV driving mode being one of the network controlled driving mode or the UAV auto-driving mode.

Example 63 is the apparatus of any of Examples 35 to 37 and 51, wherein the UAV driving mode is a UAV controller driving mode, and wherein the at least one processor is further configured to: receive a report indicating a measurement associated with a command and control (C2) link between the UAV and a UAV controller; and transmit a different UAV driving mode in response to the report.

Example 64 is the apparatus of any of Examples 35 to 63, wherein the apparatus is a base station.

Example 65 is a method of wireless communication at a network entity comprising the steps performed by the apparatus of any of Examples 35 to 64.

Example 66 is an apparatus for wireless communication, including: means for receiving uncrewed aerial vehicle (UAV) data supporting uplink communication and downlink communication with a user equipment (UE), the UE being a UAV; and means for transmitting a message including a UAV driving mode, the UAV driving mode indicating the UE to fly on a planned route.

Example 67 is a non-transitory computer-readable medium storing computer executable code, the code when executed by a processor cause the processor to: receive uncrewed aerial vehicle (UAV) data supporting uplink communication and downlink communication with a user equipment (UE), the UE being a UAV; and transmit a message including a UAV driving mode, the UAV driving mode indicating the UE to fly on a planned route.

1-252. (canceled)

253. An apparatus for wireless communication, comprising:
a memory; and
at least one processor coupled to the memory and configured to:
transmit uncrewed aerial vehicle (UAV) data supporting uplink communication and downlink communication with a network entity; and
receive, from the network entity, a message including a UAV driving mode, the UAV driving mode indicating the apparatus to fly on a planned route, the apparatus being a UAV.

254. The apparatus of claim 253, wherein the at least one processor is further configured to:
transmit a second message indicating at least one UAV supported driving mode to the network entity, wherein the UAV driving mode is based at least in part on the at least one UAV supported driving mode.

255. The apparatus of claim 254, wherein the at least one processor is further configured to:
transmit, to the network entity, route information based on the UAV driving mode being a network controlled driving mode, the route information including one or more of: a time of departure of the UAV, a departure three dimensional (3D) location of the UAV, a destination 3D location of the UAV, a time of arrival of the UAV, a UAV flight capability, a UAV operator license, a UAV mission type, a location of an obstacle in the planned route of the UAV, a real-time UAV 3D position, a UAV heading, a UAV velocity, a UAV battery state, and a UAV characteristic.

256. The apparatus of claim 254, wherein the at least one processor is further configured to:
receive, from the network entity, route information based on the UAV driving mode being a network controlled driving mode, the route information further being received based on a destination location of the UAV or an expected time of departure of the UAV originating from an application server in communication with the network entity.

257. The apparatus of claim 253, wherein the at least one processor is further configured to:
receive, from the network entity, route information based on the UAV driving mode being a network controlled driving mode, the route information including one or more of a routing path for the UAV, a location dependent allowable speed of the UAV, a location dependent allowable altitude of the UAV, an expected departure time of the UAV, an expected arrival time of the UAV, and a location of an obstacle in the planned route of the UAV.

258. The apparatus of claim 253, wherein the at least one processor is further configured to:
transmit UAV calculated route information to the network entity based on the UAV driving mode being a UAV auto-driving mode; and
receive, from the network entity, an indication of approval or denial of the planned route associated with the UAV calculated route information.

259. The apparatus of claim 258, wherein the UAV calculated route information includes one or more of: a UAV position, a time of departure of the UAV, a departure 3D location of the UAV, a destination 3D location of the UAV, a time of arrival of the UAV, a UAV flight capability, a UAV operator license, a UAV mission type, a location of an obstacle in the planned route of the UAV, a real-time UAV three dimensional (3D) position, a UAV heading, a UAV velocity, a UAV battery state, and a UAV characteristic.

260. The apparatus of claim 253, wherein the at least one processor is further configured to:
receive a second message indicating the UAV to follow the planned route, or to return to a departure location of the UAV, based on a geographic position of the UAV indicating that the UAV is not on the planned route.

261. The apparatus of claim 253, wherein the UAV driving mode is a UAV controller driving mode, and wherein the at least one processor is further configured to:
transmit, to the network entity, a request to switch the UAV driving mode to a network controlled driving mode or a UAV auto-driving mode based upon a change in a characteristic of a command and control (C2) link between the UAV and a UAV controller; and
receive a different UAV driving mode from the network entity in response to the request, the different UAV driving mode being one of the network controlled driving mode or the UAV auto-driving mode.

262. The apparatus of claim 253, wherein the UAV driving mode is a UAV controller driving mode, and wherein the at least one processor is further configured to:
receive a different UAV driving mode from the network entity in response to a UAV controller request to switch the UAV driving mode to a network controlled driving mode or a UAV auto-driving mode, the different UAV driving mode being one of the network controlled driving mode or the UAV auto-driving mode.

263. The apparatus of claim 253, wherein the UAV driving mode is a UAV controller driving mode, and wherein the at least one processor is further configured to:
transmit a report indicating a measurement associated with a command and control (C2) link between the UAV and a UAV controller; and
receive a different UAV driving mode from the network entity in response to the report.

264. The apparatus of claim 253, wherein the at least one processor is further configured to:
transmit a second message indicating at least one UAV supported driving mode to the network entity, wherein the UAV driving mode is based at least in part on the at least one UAV supported driving mode;
wherein the second message further indicates a UAV preferred driving mode, wherein the UAV driving mode is the UAV preferred driving mode.

265. The apparatus of claim 253, wherein the planned route is associated with a route path precision based on the UAV driving mode being a network controlled driving mode, the route path precision being meter level, street level, block level, or network entity level.

266. The apparatus of claim 253, wherein the UAV driving mode is based at least in part on one or more of a UAV destination, a quality of service (QOS) of the uplink communication or the downlink communication, a geometry of the planned route, and UAV traffic in the planned route.

267. The apparatus of claim 253, wherein the at least one processor is further configured to:
transmit UAV calculated route information to the network entity based on the UAV driving mode being a UAV auto-driving mode;
receive, from the network entity, an indication of approval or denial of the planned route associated with the UAV calculated route information; and
receive, from the network entity, route information based on the UAV driving mode being switched to a network controlled driving mode based on the denial.

268. The apparatus of claim 253, wherein the at least one processor is further configured to:
transmit at least one of:
a geographic position of the UAV periodically to the network entity during transit of the UAV on the planned route, or
a measurement of a reference signal, a reference signal, or cell information to the network entity during transit of the UAV on the planned route, the measurement, the reference signal, or the cell information indicating the geographic position of the UAV.

269. The apparatus of claim 253, wherein the at least one processor is further configured to:
receive, from the network entity, one of:
route information based on the UAV driving mode being a network controlled driving mode, the route information indicating:
an entirety of the planned route based on a destination location of the UAV being within a cell of the network entity, or
a portion of the planned route based on the destination location of the UAV being within a cell of a different network entity, or
calculated route information originating from a different network entity based on the UAV driving mode being the network controlled driving mode.

270. The apparatus of claim 253, wherein the at least one processor is further configured to:
transmit UAV calculated route information to the network entity or to a different network entity in a radio resource control (RRC) message or a non-access stratum (NAS) based on the UAV driving mode being a UAV auto-driving mode; and
receive, from the network entity or the different network entity, an indication of approval or denial of the planned route associated with the UAV calculated route information.

271. The apparatus of claim 253, wherein the at least one processor is further configured to:
transmit UAV calculated route information to in a radio resource control (RRC) message or a non-access stratum (NAS) message based on the UAV driving mode being a UAV auto-driving mode;
receive an indication of denial of the planned route associated with the UAV calculated route information; and
receive route information for a UAV auto-driving mode or a network controlled driving mode based on the denial.

272. The apparatus of claim 253, wherein the UAV driving mode is a UAV controller driving mode, and wherein the at least one processor is further configured to:
transmit, to the network entity, a request to switch the UAV driving mode to a network controlled driving mode or a UAV auto-driving mode based upon a change in a characteristic of a command and control (C2) link between the UAV and a UAV controller; and
receive a different UAV driving mode from the network entity in response to the request, the different UAV driving mode being one of the network controlled driving mode or the UAV auto-driving mode;
wherein the change in the characteristic of the C2 link is one of:
a loss in connection of the C2 link,
a reference signal received power (RSRP) of a reference signal carried in the C2 link being lower than a threshold, or
indicated in the request, the request further indicating a UAV preferred driving mode.

273. A method of wireless communication at a user equipment (UE), comprising:
transmitting uncrewed aerial vehicle (UAV) data supporting uplink communication and downlink communication with a network entity; and
receiving, from the network entity, a message including a UAV driving mode, the UAV driving mode indicating the UE to fly on a planned route, the UE being a UAV.

274. An apparatus for wireless communication, comprising:
a memory; and
at least one processor coupled to the memory and configured to:
receive uncrewed aerial vehicle (UAV) data supporting uplink communication and downlink communication with a user equipment (UE), the UE being a UAV; and
transmit a message including a UAV driving mode, the UAV driving mode indicating the UE to fly on a planned route.

275. The apparatus of claim 274, wherein the at least one processor is further configured to:
receive a second message indicating at least one UAV supported driving mode, wherein the UAV driving mode is based at least in part on the at least one UAV supported driving mode.

276. The apparatus of claim 275, wherein the at least one processor is further configured to:
receive route information based on the UAV driving mode being a network controlled driving mode, the route information including one or more of: a UAV position, a time of departure of the UAV, a departure location of the UAV, a destination location of the UAV, a time of arrival of the UAV, a UAV flight capability, a UAV operator license, a UAV mission type, a location of an obstacle in the planned route of the UAV, a real-time UAV three dimensional (3D) position, a UAV heading, a UAV velocity, a UAV battery state, and a UAV characteristic.

277. The apparatus of claim 275, wherein the at least one processor is further configured to:
transmit route information based on the UAV driving mode being a network controlled driving mode, the route information further being transmitted based on a destination location of the UAV or an expected time of departure of the UAV originating from an application server in communication with the apparatus.

278. The apparatus of claim 274, wherein the at least one processor is further configured to:
transmit route information based on the UAV driving mode being a network controlled driving mode, the route information including one or more of a routing path for the UAV, a location dependent allowable speed of the UAV, a location dependent altitude of the UAV, an expected departure time of the UAV, an expected arrival time of the UAV, and a location of an obstacle in the planned route of the UAV.

279. The apparatus of claim 274, wherein the at least one processor is further configured to:
receive UAV calculated route information based on the UAV driving mode being a UAV auto-driving mode; and
transmit an indication of approval or denial of the planned route associated with the UAV calculated route information.

280. The apparatus of claim 279, wherein the UAV calculated route information includes one or more of: a UAV position, a time of departure of the UAV, a departure location of the UAV, a destination location of the UAV, a time of arrival of the UAV, a UAV flight capability, a UAV operator license, a UAV mission type, a location of an obstacle in the planned route of the UAV, a real-time UAV three dimensional (3D) position, a UAV heading, a UAV velocity, a UAV battery state, and a UAV characteristic.

281. The apparatus of claim 274, wherein the at least one processor is further configured to:
transmit a second message indicating the UAV to follow the planned route, or to return to a departure location of the UAV, based on a geographic position of the UAV indicating that the UAV is not on the planned route.

282. A method of wireless communication at a network entity, comprising:
receiving uncrewed aerial vehicle (UAV) data supporting uplink communication and downlink communication with a user equipment (UE), the UE being a UAV; and
transmitting a message including a UAV driving mode, the UAV driving mode indicating the UE to fly on a planned route.
